(19) United States
(12) Patent Application Publication
(10) Pub. No.: US 2015/0324922 A1
(43) Pub. Date: Nov. 12, 2015

(54) SYSTEM AND METHOD FOR SIMULATING THE OPERATIONAL CLAIMS RESPONSE TO A CATASTROPHIC EVENT

(71) Applicant: Guy Carpenter & Company, LLC, New York, NY (US)

(72) Inventors: Beverley Adams, New York, NY (US); Gareth Bowers, New York, NY (US)

(73) Assignee: Guy Carpenter & Company, LLC, New York, NY (US)

(21) Appl. No.: 14/271,915

(22) Filed: May 7, 2014

(51) Int. Cl. G06Q 40/08; G06Q 10/06

(52) U.S. Cl. CPC G06Q 40/08; G06Q 10/067

(57) ABSTRACT

A system and method for receiving claims information for a CAT event, the claims information including a number of claims for the CAT event, receiving a plurality of variable modifiers for a response to the CAT event by an insurance company, wherein the variable modifiers include an output of at least one sub-model having a defined sub-model time period, running a model simulation of the response to the CAT event by the insurance company based on the claims information and the plurality of variable modifiers, wherein the model simulation is based on a defined model time period that is different from the defined sub-model time period and outputting results of the simulation.

### BACKGROUND

A catastrophic (CAT) event includes events such as natural disasters (e.g., earthquakes, floods and hurricanes) and man-made disasters (e.g., terrorist attacks). These events are typically low-probability, high-cost events. Businesses and individuals may purchase CAT insurance to protect themselves against such CAT events.

While these events have a low probability of occurring, they tend to focus attention on the insurance companies that underwrite the CAT insurance because many people are normally affected by the CAT event. Thus, when a CAT event occurs, the insurance companies typically receive a large influx of claims. It is important for the insurance companies to effectively settle all claims for these CAT events in the most efficient manner.

Efficiency in settling claims deals takes in a variety of issues and concerns for the insurance company. For example, the insurance companies would like to settle claims in a timely manner for the purpose of customer relations and retaining customers. In addition, the insurance company also wants to avoid negative publicity related to being unresponsive or taking too long to settle valid claims. In some extreme cases, a lack of responsiveness in processing claims could lead to investigations by state insurance boards or even criminal investigations. On the other hand, the insurance companies do not want to settle fraudulent claims in the name of speed and have to manage the cost associated with settling these claims (e.g., the cost of personnel assigned to settling the claims).

### SUMMARY

A method for receiving, by a processor, claims information for a CAT event, the claims information including a number of claims for the CAT event, receiving, by the processor, a plurality of variable modifiers for a response to the CAT event by an insurance company, wherein the variable modifiers include an output of at least one sub-model having a defined sub-model time period, running, by the processor, a model simulation of the response to the CAT event by the insurance company based on the claims information and the plurality of variable modifiers, wherein the model simulation is based on a defined model time period that is different from the defined sub-model time period; and outputting results of the simulation.

A system having a processor and a non-transitory computer readable storage medium that stores a set of instructions. The set of instructions, when executed, cause the processor to receive claims information for a CAT event, the claims information including a number of claims for the CAT event, receive a plurality of variable modifiers for a response to the CAT event by an insurance company, wherein the variable modifiers include an output of at least one sub-model having a defined sub-model time period, run a model simulation of the response to the CAT event by the insurance company based on the claims information and the plurality of variable modifiers, wherein the model simulation is based on a defined model time period that is different from the defined sub-model time period, and output results of the simulation.

### BRIEF DESCRIPTION OF THE DRAWINGS

FIG. 1 illustrates a generic claims process flow.

FIG. 2 shows a modified system diagram having model inputs, model simulation and model outputs.

FIGS. 3a-b show tables that include exemplary model inputs for the simulator.

FIG. 4 shows an example of an input screen that allows an individual insurance company to select the individualized model set-up or “claims journey” for the insurance company.

FIG. 5 shows exemplary data and information that may be used to determine the claims presentation in a 15-minute interval.

FIG. 6 shows an example of the call distribution/claims arrival for the 15-minute intervals using the data and information from FIG. 5.

FIG. 7 shows a view that transitions the 15-minute data of FIG. 6 into daily and weekly intervals.

FIG. 8 shows a view that provides an analysis of the staff required to clear the FNOL backlog as determined by the sub-model.

FIG. 9 shows the data and information for the variations of claims handling by an adjuster for each of the workflows.

FIG. 10 shows an example of the adjuster production based on the data and information from FIG. 9.

FIG. 11 shows the summary of an adjuster sub-model on a weekly basis.

FIGS. 12a-c shows example formulae that the simulator uses to calculate claims process values.

FIG. 13 shows a first exemplary output in the form of a dashboard view that summarizes the findings for the given CAT response plan and scenario.

FIG. 14 shows a grouping of multiple scenarios that may be run with different parameters to show different results.

FIG. 15 shows an example of an output that allows two different user scenarios to be compared.

FIG. 16 shows an exemplary financial dashboard view output.

FIG. 17 shows a resource dashboard view.

### DETAILED DESCRIPTION

The exemplary embodiments may be further understood with reference to the following description of the exemplary embodiments and the related appended drawings, wherein like elements are provided with the same reference numerals. The exemplary embodiments relate to a system and method for measuring and/or predicting the performance of an insurance company's post-event operational response process for different CAT event scenarios. In the exemplary embodiments, a model is built around a typical “claims journey”, which captures each step of the response process from initial notification of a loss through to settlement and recovery.

It should be noted that the exemplary embodiments describe a generic claims journey and its corresponding model. However, those skilled in the art will understand that different insurance companies may have a customized claims journey (e.g., additional steps are added to the claims process, the steps of the claims process vary in an order they are applied, etc.) and the exemplary embodiments, including the model, may be modified in accordance with the principles described herein for the generic claims journey to address each insurance company's specific operational processes.

The exemplary embodiments may be used by an insurance company in a variety of manners to assist in the handling of claims for a CAT event. The exemplary embodiments may be used as a strategic planning tool to assess what claim handling arrangements and targets might be suited to which types of CAT event. For example, at what point does Business As Usual develop into a different arrangement for adjusting and servicing clients, and in what circumstances does the scale of a catastrophe demand a radically different approach. Under these different grades of response type, what are the likely expectations on resources required, cash flow and service levels?

In another example, the exemplary embodiments may be used as an operational testing tool to validate logistics arrangements for CAT events and determine at what point they “fail”. For example, there may be a large CAT event and simply not enough adjusters available to support the bands of claims intended for the adjusters. In that case, either alternative staffing is needed (e.g., shipping people in from another area or business unit) or an alternative approach (e.g., pay claims without visit based on damage estimates observed by remote sensing).

In a further example, the exemplary embodiments may be used as a response planning tool in the event of an actual CAT event, where there is an ever-improving knowledge of actual claims and the operational response plan previously envisaged may need to be changed, in real time, to reflect the reality of the CAT event.

Throughout the remainder of this description, it will be described that an insurance company responding to the CAT event is executing the exemplary embodiments. However, it is noted that it is not necessary that the insurance company be the entity that is executing the exemplary embodiments. Other entities such as a consulting firm that is advising the insurance company may also execute the exemplary embodiments and provide the insurance company with outputs and/or recommendations.

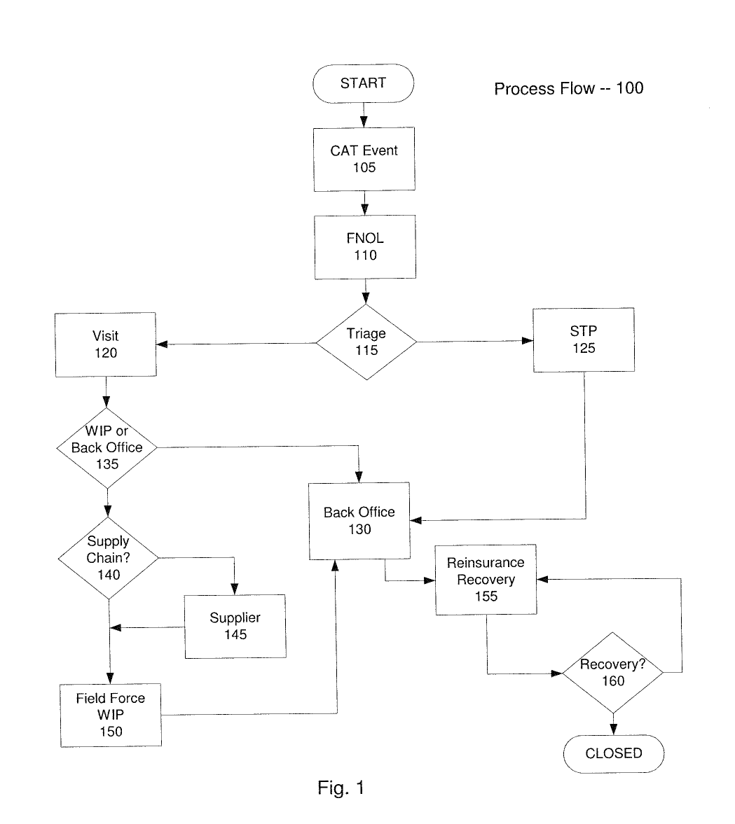

FIG. 1 illustrates a generic claims process flow 100. The process flow begins when a CAT event occurs and ceases when the last claim is settled and recovered. Thus, the process flow is a time varying model, where inputs are added at intervals along this timeline, and interim results are generated at each step of the way. The selected time domain of the model may affect the volume of calculations that are performed. The model inputs and parameters at each decision point may vary among different insurance companies as they deviate from this generic claims process flow.

The process flow 100 begins at step 105 when the CAT event occurs. The process flow 100 then continues to a First Notification of Loss (“FNOL”) step 110. Typically, this step includes contact with the customer and a decision (either automated or human to the claim presented) as to how to route the claim through the organization. The routing may involve a site visit. The routing may also be as simple as sending payment following a review of the claim. In another example, the routing may include a complex customer interaction with loss adjusters, surveyors, builders etc. As will be described in greater detail below, the model may reflect the number of staff involved in this function and their production ability/time to go through the process.

This can be dynamic and will often require flexibility especially in times of stress following CAT events. The response to the Christchurch Earthquake, for example, saw a process change at the request of municipal authorities. In the original process, adjustors assessed the amount of the claim and payment was recommended to an insurer who then considered the option of cash settling with customers following the visit, but the process changed to a full hand holding and overseeing of building reinstatement. Thus, the model may be flexible to handle such changes to the process. As will be described in detail below, a claims generator will make assumptions from CAT models or derive from actual historical data an output of a volume of claims and categorize these claims in quantum amount bands to simulate the claims entering the FNOL phase. The model will simulate the fact that the claims arrive over time and not all on day one.

It should be noted that it is possible for settlement to occur at any step of the process flow 100 after the CAT event 105. For example, at FNOL 110 a claim may be pre-inception and repudiated, at visit step 120 a claim may be settled on site. Other examples may include a claim that goes down a straight through processing (“STP”) 125 route as it is one for payment and at field force step 150 a claim can be settled in the normal course of claims handling, whether this is payment, repudiation or withdrawn.

The next step is triage 115 that is a decision stage where the initial routing of the claims is selected. This selection may be influenced by knowledge of the event itself, predetermined thresholds for visits or no visit, complexity, urgency, fraud indicators, etc. Often this involves a scripted conversation with a customer where an indication of reserve is obtained and the individual's circumstances. For example, where the customer is displaced as the property is uninhabitable or the business cannot operate this may form an automatic decision to visit. It should be noted that the model can cater for the FNOL process to occur outside the insuring entity. For example, where brokers are involved, the brokers may make routing decisions prior to notifying insurers that the claim has occurred. From here the claim will go either down a route to visit (step 120), or after a conversation/information presented, enter an alternative route such as appointment of contractors or suppliers or a form of STP (step 125). The model will reflect the staff available and time taken to go through this process dependent on production ability. It should be noted that in many circumstances this decision/triage takes place within the FNOL teams, but can be split where specific claims require additional attention before a decision regards routing, for example, in cases where fraud is suspected.

The STP step 125 involves any form of alternative routing other than a visit. For example, there may be an agreement that all claims below a certain value will be fast tracked or simply paid. If this is the case, those claims will go from the triage assessment in step 115 to the back office teams (step 130) to settle. There is also opportunity for large claims to be flagged as a total loss in extreme CAT events. For example previous incidents such as Tohoku have seen large-scale settlement by insurers on a total loss basis, following a review of available satellite imagery. The use of aerial imagery after Katrina was also central to claims settlement. Thus, these other examples of alternative claims settlement avoid a visit 120.

The visit step 120 is normally fulfilled by loss adjusters, but in some circumstances could be a two-tiered process where a supplier/contractor visits up to a certain value with adjusters involved beyond that. Visiting delays may be built into the model to account for access difficulties, work overload or additional factors that may cause issues for a field force to visit a site immediately. The visiting delays are a variable parameter as the individual event dictates whether this becomes a factor. The implementation of such variable time delays into the model will be described in greater detail below.

After the visit step 120, a further decision step 135 is made to determine whether the field force retains ownership of the claim and it becomes part of their work in progress (WIP) or whether the claims are passed back immediately following a visit to the back office function (step 130). This will be agreed with an insurer based upon an in-depth analysis of workflows and preferred routing parameters in conjunction with a view of historic data to analyze past performance (e.g., a first site visit will resolve 50% of the claims) or an amount of loss figure (e.g., all claims under $100,000 will be resolved by a first site visit). An example of a visit stage 120 resolution may be that at the visit stage, it is determined the claim is straightforward and it was agreed on site with no additional work to be undertaken by the field force. Such a claim may be passed to the back office 130 to process settlement. In an opposite example, the visit stage 120 may indicate the claim is a complex structural/business interruption issue that would require the repairs/business recovery overseeing through to conclusion by the field force.

Addressing the back office step 130, the operations undertaken by the back office will vary among insurance companies. The model may reflect the number of staff that performs this function, their ability to process claims in terms of production level and the time taken for each claim to pass through the process. A mixture of activity will prevail from processing payments following a field visit or at final report stage to handling of those claims deemed to be ear marked for STP or liaising with adjusters during the claims management stage to make decisions/agree interim payments. Often as the pressure is felt immediately at the FNOL step 110, back office staff is utilized in the initial stages. As claims are processed, the requirement for staffing at the back office reflects the volume going through the back office.

If the decision in step 135 is that the claim becomes WIP for the field force, the process flow 100 continues to the decision step 140 that involves whether to involve external suppliers in the claims process. If a supplier is involved, the process flow continues to step 145 that typically involves a contractor/surveyor/contents supplier whose activity is often managed by an adjuster. Where no supplier is involved, the process flow 100 continues to step 150 where the field force solely handles the claim. For example, it may be that the responsibility to present evidence of reinstatement resides with the customer and the relationship is managed by the adjuster who will send reports when satisfied expenditure or reinstatement has taken place. If a supplier is involved in step 145, the process also continues to step 150 where there is a three-way dialogue between adjuster (field force WIP process), customer and supplier to ensure that goods and/or services are supplied and invoices submitted for approval. This is often a circular process until such time as all invoices are presented and a final report can be submitted to back office teams 130. The model may reflect the resources available, the production ability and the time taken to handle claims at differing monetary value levels before proposing final settlement.

When the field force WIP step 150 is complete, the process continues to the back office 130 to settle the claims. As described above, settlement can take place at numerous stages along the claims journey in a variety of methods including, for example, payment, visit then payment, repudiation, withdrawn claim or pre inception issues, etc. In any case, the process flow 100 for dealing with the customer ends up with the back office 130. When the back office 130 is finished processing the claim (i.e., the claim is settled), the “claims journey” for that individual claim is closed with respect to the customer and the customer service that is being provided by the insurance company. Thus, the model for the claims journey may be considered to be finished at this point.

However, while the customer portion of the claim may be settled, the claim may not be completely closed with respect to the insurance company because the insurance company may be entitled to a recovery from reinsurers for some or the entire claim. Thus, after a claim (or a set of claims) is completed with respect to the customer, a separate flow may be set-up by the insurance company to track the flow of the reinsurance recovery. It is noted that the reinsurance flow is not a necessary step of the claims flow. An individual insurance company may decide that it is not necessary to model the reinsurance recovery, but may simply end the model flow at the back office 130 stage. If the reinsurance is incorporated as a separate flow it would occur after the back office 130 completes the customer claims process. The process flow 100 may continue to the reinsurance recovery step 155 where that team will prepare the claim for the reinsurers. If recovery is made in step 160, the claim is closed. Otherwise the process may be repeated several times in attempt to collect from the reinsurer. Those skilled in the art will understand that there may be reasons that the reinsurer rejects the claims and when the rejection is final, this may also complete the claims journey for this claim. Those skilled in the art will also understand that the recovery from reinsurers may not be on a claim-by-claim basis, but may involve the grouping of a number of claims to submit to one or more reinsurers. At the completion of the process flow 100, each claim will have completed its claims journey.

As described above, the process flow 100 describes a generic claims journey for the claims of a CAT event. Individual insurance companies may add, delete or modify steps in the claims journey based on their individual practices. The following will describe the inputs to the model of the generic claims journey illustrated in the process flow 100, the simulation runs of the model and example outputs from the model.

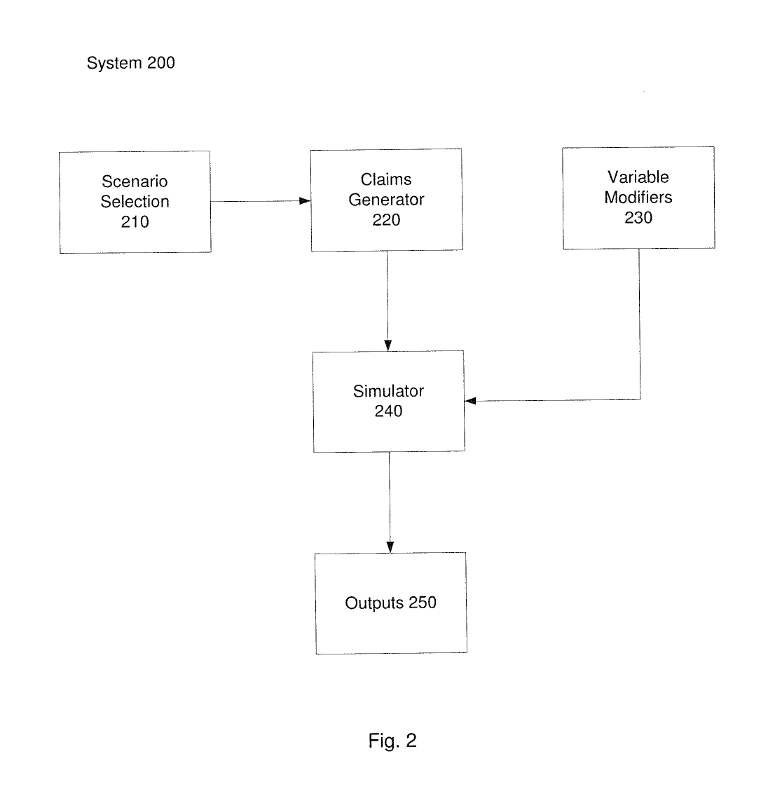

FIG. 2 shows a modified system 200 diagram having the inputs 210, 220, 230 into the model, the simulator 240 that executes the model and the outputs 250 of the model. Each of these components will be described in greater detail below.

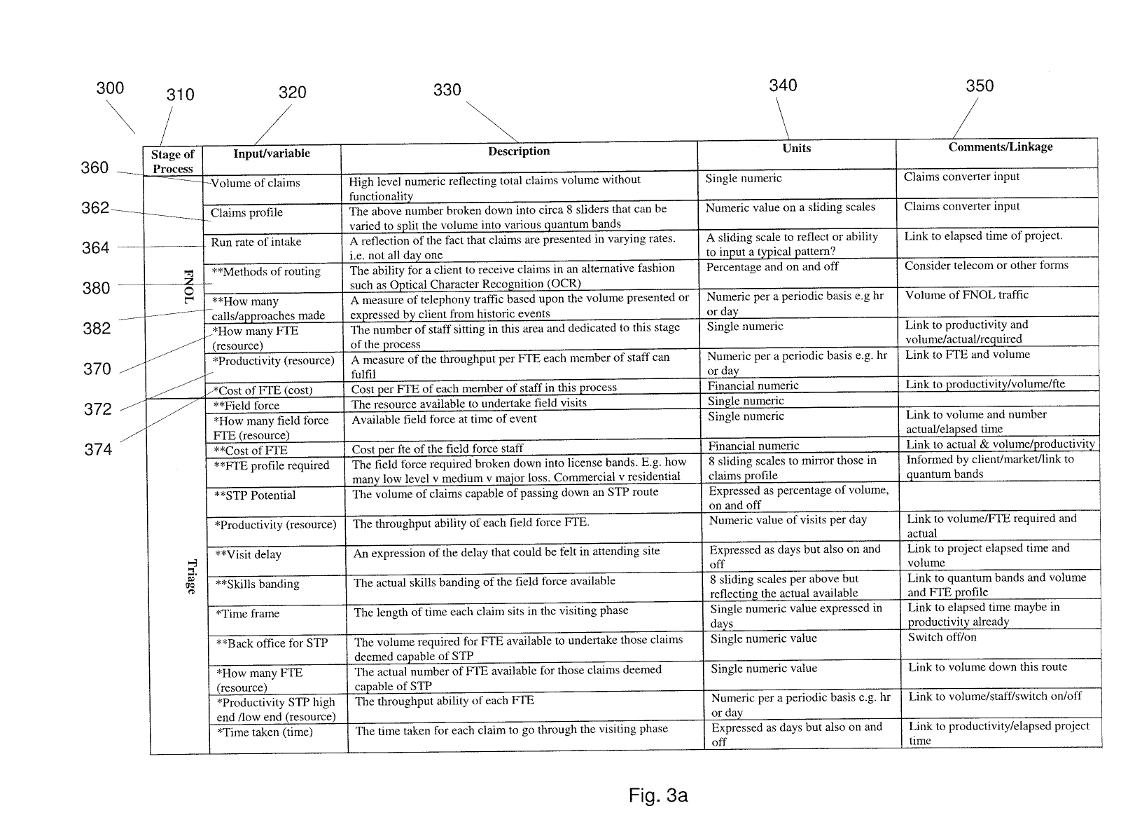

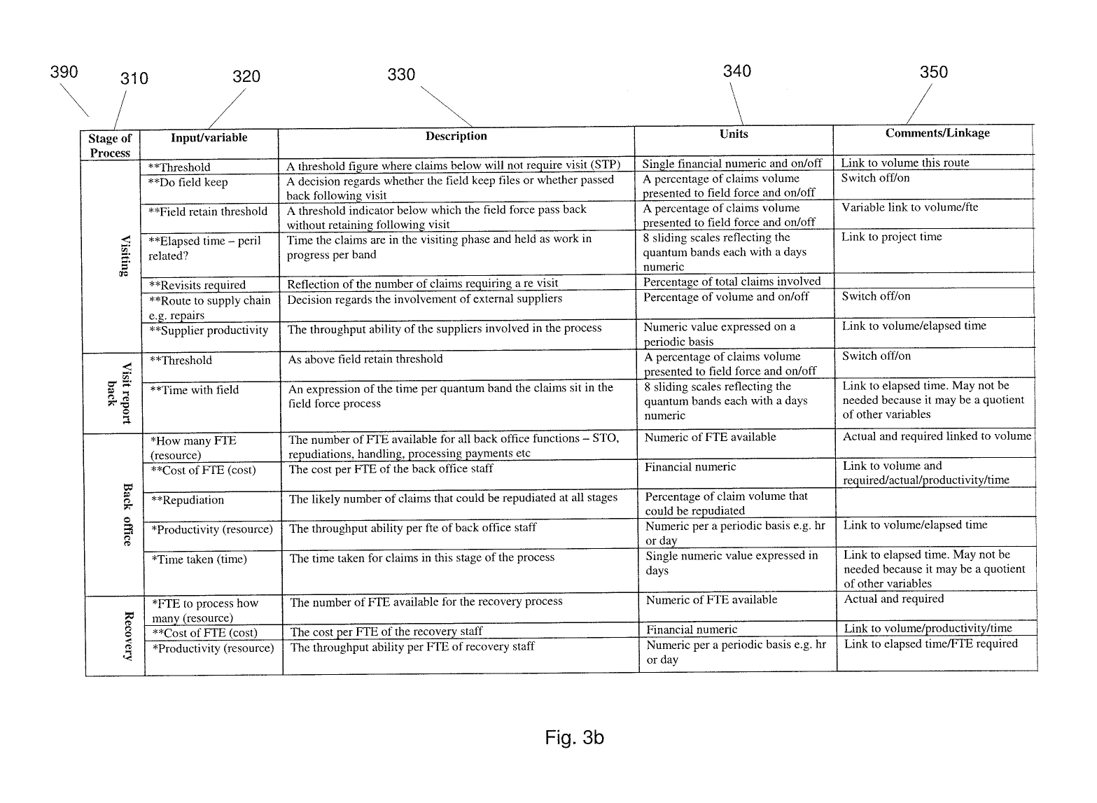

FIGS. 3a-b show tables 300 and 390 that include exemplary model inputs for the simulator 240. These inputs will be described generally below, but each of FIGS. 3a-b shows the stage of the process 310, the input 320, a description of the input 330, the units for the variable 340 and the linkage for the variable 350. Examples of these inputs will be described below when describing the system 200.

The first input is the CAT event scenario selection 210. The simulation model may use any of the commercially available CAT model scenarios (e.g. a model from Risk Management Solutions, AIR Worldwide, EQECAT, or GCAT) as a basis for stress testing the operational performance of insurance company CAT event response plans and strategies. By allowing the insurance company to select the CAT model that it currently uses for its risk management, this ensures that the simulation of the CAT event claims process is aligned with the existing financial risk management practices that cater to CAT events of differing return periods. This allows the exemplary embodiments to evaluate whether an insurance company is operationally ready to respond to the same CAT events (e.g., 1 in 200 year for Solvency II compliance) for which it models its portfolio and for which it buys reinsurance protection.

For the sake of clarity, it is noted that the CAT model referred to in the previous paragraph is different from the exemplary embodiments of the claims process model being described herein. Those skilled in the art will understand that a CAT model is the process of using computer-assisted calculations to estimate the losses that could be sustained due to a CAT event. In contrast, the claims process model being described herein is related to the processing of the claims for the CAT event.

Once the scenario selection is complete, a claims generator 220 generates a CAT event claims profile that includes the number and monetary value/quantum bands of claims for input into the simulator 240. It should be noted that this estimation/calculations sits outside the model and may involve in-depth analysis of previous historic claim data to inform assumptions. These datasets may be derived from modeled financial losses. For each event, the claims generator 220 generates the claims volume that may be a single numeric value representing the total number of claims arising from this event and the claims monetary value. These claims may also be organized into various quantum or strata based on the magnitude of the monetary value. Referring to table 300 in FIG. 3a, the input 360 is the volume of claims and the input 362 is the claims profile (or magnitude/quantum of claims). In this particular example, the claims are broken down into eight (8) quantum bands. However, those skilled in the art will understand that any number of quantum bands may be selected for the model.

To provide a specific example, the insurance company may have a CAT model for a hurricane along a defined path across Florida. The claims generator 220 may include a dataset that describes the number and the monetary value/quantum of claims for such an event. For example, the insurance company is expected to receive 5,000 claims from the event and these 5,000 claims may be placed into eight quantum bands as follows:

| | | |
|---|---|---|
| Band 1 | ≦$50,000 | 1,000 claims |
| Band 2 | $50,001-$100,000 | 1,000 claims |
| Band 3 | $100,001-$200,000 | 1,000 claims |
| Band 4 | $200,001-$300,000 | 500 claims |
| Band 5 | $300,001-$500,000 | 500 claims |
| Band 6 | $500,001-$750,000 | 500 claims |
| Band 7 | $750,001-$1,000,000 | 250 claims |
| Band 8 | >$1,000,000 | 250 claims |

Based on this selected CAT event and the CAT model used by the insurance company, claims generator operator of the model will input this information into the simulator 240 to be run in the model. It is noted that the number of bands, the range of the bands and the number of claims that fall into the bands are only exemplary and that the insurance company may define any number of bands and ranges based on its individual claims process. The number of quantum bands may be a predetermined number or may be defined by a user for the particular CAT event. The range of each of the quantum bands may be predetermined by the insurance company based on the range of the monetary values of the expected claims or may be based on attempting to group a defined number of claims into each band (e.g., eight (8) bands having an equal number of claims).

As described above, the number and monetary values of the claims is time variable. That is, an insurance company may receive the claims during the days, weeks and months after an event takes place. The rate at which the insurance company receives claims is not a static input at time (T0) when the event occurs, but instead the claims are received along a response timeline according to a specified run rate. This run rate information is adjustable and may be selected based on information specific to the insurance company and/or event. For example, the insurance company may have historical data that indicates that after a CAT event, the insurance company typically receives X % of the claims during the first week after the event, Y % of the claims during the second week after the event and so on. In another example, the insurance company may have historical data that indicates a certain run rate for a hurricane and a different run rate for an earthquake. Referring to table 300 in FIG. 3a, the input 364 is shown as the run rate of intake.

As shown in the table 300, the inputs from the claims generator 220 are only applicable to the FNOL stage of the process. Those skilled in the art will understand that since the FNOL is the first indication to the insurance company that there is going to be a claim, all claims must pass through this stage, even where this takes place outside the insurance company, for example, in a broker who has a delegated authority to receive claims. In the model this would materialize as affecting the run rate arrival at the insurer albeit the claims journey has started and therefore the claims parameters described above will be applicable to this stage. The claims generator 220 will input these parameters into the simulator 240 based on the selected scenario.

It is noted that the above examples of the claims generator 220 generating input for the model is based on a predicted CAT event. It is also possible that the claims generator 220 has actual values for a CAT event for input into the model. For example, if the purpose of running the model is to examine the response to an actual CAT event, the claims generator 220 may have the actual number of claims and monetary values for the CAT event that is being examined. Similarly, if the purpose of running the model is to determine how the insurance company is responding to an ongoing CAT event, the claims generator 220 may have a combination of actual data and model data (e.g., during the first two weeks after the event, the claims generator has the number of actual claims and the monetary value of those claims, but since it is expected that additional claims will arrive for at least another 8 weeks, the claims generator 220 has modeled data for the remaining 8 weeks). Thus, the claims generator 220 is not limited to only generating claims data for expected claims.

The variable modifiers 230 generally comprise two types of data, primary variable modifiers and secondary variable modifiers. It is noted that throughout this description, the variable modifiers may also be referred to as “parameters.” The primary variable modifiers include, for example, the amount of time taken to respond to and settle claims, the cost involved in responding to the event and the personnel required to perform the response and their relative productivity (including adjusters, back office, etc.).

Referring to FIG. 3a, some exemplary primary variable modifiers 370-374 are described. The input 370 is the number of persons (e.g., full-time equivalents (“FTE”) on the team dedicated to the FNOL stage of the process). The input 372 is the productivity of each member of the team. The input 374 is the cost of each FTE. These example primary modifiers 370-374 are shown for the FNOL stage. However, unlike the claims inputs discussed above, the primary variable modifiers may be input for all the stages of the process. The tables 300 and 390 show additional exemplary primary variable modifiers for the other stages of the process that are labeled with an asterisk (*).

The model can be run using the primary variable modifiers alone. However, the secondary variable modifiers are weighting factors that can either be turned on/off or varied, which can customize the simulation to each client's response process (from initial loss notification to settlement) and claims handling philosophy. The model captures this complexity through a series of secondary variable modifiers. Referring to FIG. 3a, some exemplary secondary variable modifiers 380-382 are described. The input 380 is a method of routing that indicates that the insurance company may receive claims in an alternative fashion such as optical character recognition (“OCR”) including the percentage of claims received in this manner. The input 382 is a measure of the telephone traffic based upon the volume presented or expressed by the insurance company based on historic data. The tables 300 and 390 show additional exemplary secondary variable modifiers for the other stages of the process that are labeled with a double asterisk (**). A review of these secondary inputs, show how these inform the resource, skill set, cost or elapsed time of the end-to-end claims journey.

As described above, the exemplary embodiments allow the model to be customized for the needs of the individual insurance company, without having to completely rebuild the model. That is, the individual insurance company may modify specific parameters such as the variable modifiers 230 to address its individual needs. However, the underlying model remains unchanged.

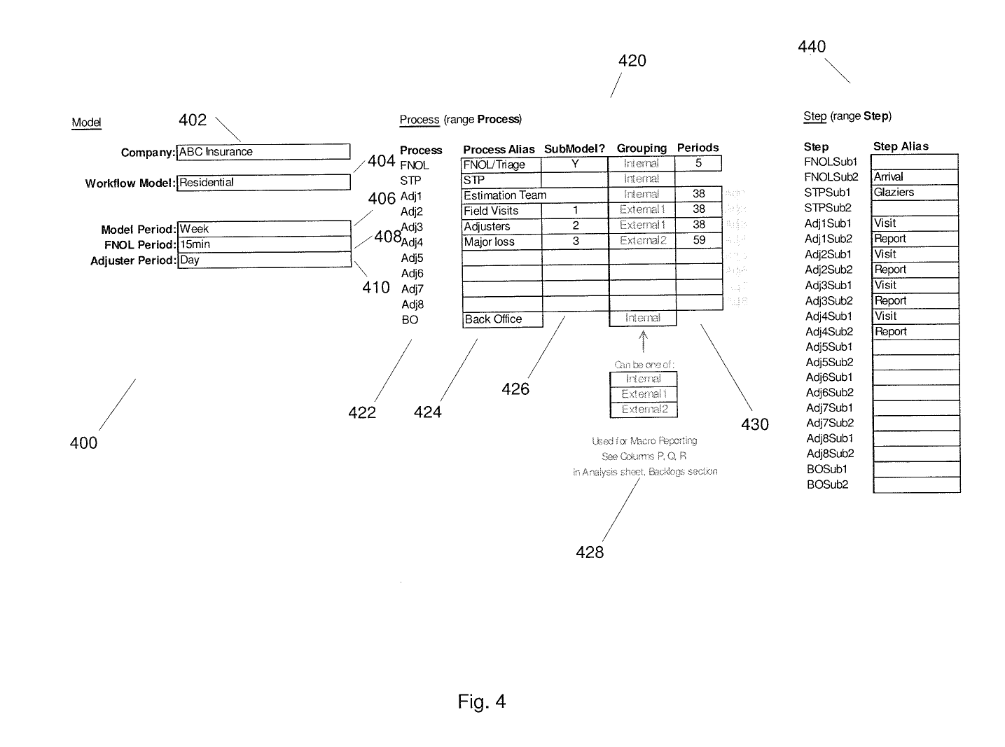

FIG. 4 shows an example of an input screen 400 that allows an individual insurance company to select the individualized model set-up or “claims journey” for the insurance company. The field 402 allows the insurance company (or the entity that is running the model) to identify the insurance company for which the model is being run. The field 404 indicates the type of workflow that is being run. As described above, the process flow 100 is a generic process flow that describes one possible flow for the handling of claims. Individual insurance companies may have a modified version of this flow that adds or deletes steps from the flow or changes the content and/or order of the flow. The individual insurance companies may define its own process flows and then select the defined process flow using the field 404 of input screen 400. In this example, the insurance company has selected a residential workflow that has been defined for this insurance company. It should be noted that an insurance company may have multiple workflows depending on the type of insurance. Another example of a workflow for this insurance company may be a commercial workflow that varies from the residential workflow.

The input screen 400 also allows the insurance company to select the time frames (periods) 406-410 for the model. In this example, the model period 406 is a week, the FNOL period 408 is 15 minutes and the adjuster period 410 is one day. These values are then used when the simulations are run. It should be noted that the model provides output by “period” (typically weeks). However, for some of the data, a period of a week is not granular enough to provide the insurance company with the proper insight into the claims process. Thus, the model, as shown by the selections 406-410 allows for a user to set different time periods for different stages of the claims process to achieve the desired granularity in the output results for the model. Since the model is defaulted to a period of weeks, these finer granularity periods require further sub-model input into the model to account for the differing periods. Exemplary uses of these model periods and the associated sub-models will be described in greater detail below.

The table 420 of the input screen 400 allows any of the steps of the workflow to be customized. Thus, referring back to the sample workflow of FIG. 1, any of the steps may be customized for the individual insurance company using the model. The column 422 shows the steps corresponding to the steps of FIG. 1 that may be customized. In the example of FIG. 4, the processes shown in column 422 correspond to workflow steps of FIG. 1 as follows: FNOL (110), STP (125), Adj 1-8 (120, 150) and B(ack) O(ffice) (130). It is noted that Adj 1-8 refers to the steps that are performed by adjusters such as visits 120 and field force WIP 150 and various adjustments that may be made to the parameters affecting these steps. The processes of column 422 are only exemplary and other processes corresponding to a particular workflow may also be included.

The column 424 provides the process alias of the process. This is merely a name for the adjustment that is being made to the workflow step. The column 426 shows whether a sub-model is being used for the step and/or which sub-model is to be used. For example, the FNOL step will include a sub-model input. An example of this sub-model input will be provided below. In another example, the adjusters will also include a sub-model and this sub-model is identified as adjustment sub-model 2. An example of this sub-model will also be provided below.

The column 428 shows the grouping for each step of the process. The grouping refers to the allocation of the cost for the step, e.g., whether it is an internal cost to the insurance company or an external cost that is incurred by a third party. This identification of the grouping allows the insurance company to understand whether the costs are loss adjustment expenses (“LAE”) or allocated loss adjustment expenses (“ALAE”).

The last column 430 shows the number of periods for which the sub-model is active. As described above, the model was defined as having a base period of a week as selected in model period 406. Thus, the periods in column 430 are shown in the period units of the base period. For example, the FNOL sub-model is active for 5 weeks. Thus, the sub-model input for the FNOL step will be a sub-model input for 15-minute periods (based on the selection of that period in FNOL period 408) for 5 weeks. Similarly, the sub-model input for the Adj3 Adjusters will be a sub-model input for daily periods (based on the selection of that period in Adjuster period 410) for 38 weeks. In a final example, the sub-model input for the Adj4 major Loss will be a sub-model input for daily periods (based on the selection of that period in Adjuster period 410) for 59 weeks. The difference in the time frame between the Adj3 and Adj4 for the same step may be explained, for example, by the empirical evidence that resolving major loss claims takes a longer time than resolving a normal loss that requires a visit.

The table 440 allows for the customization of the various defined sub-models. For example, the customization of the adjustor sub-models may have two components. A first component may be that the adjuster's diary function may be adjusted. The diary function may refer to, for example, the number of claims that the adjuster receives from the insurance company. The adjuster may be scheduled to receive ten (10) claims in a defined time period (e.g. day). However, the adjuster may actually receive twenty (20) claims because the adjuster can hold some of these claims in the adjuster's diary. In this way, claims are moved to the adjuster faster and be cleared by the adjuster as needed because they are already sitting in the adjuster's diary. The table 440 may be used to customize the adjuster sub-model to show this increased diary activity.

A second component for customizing the adjuster's sub-models may be, for example, defining a variable rate for adjuster visits. For example, experience has shown that immediately after the CAT event, the adjusters may operate at a higher efficiency or with higher urgency in the immediate aftermath. However, after some time has passed, the adjuster may settle down to a slower visit rate because of becoming tired, needing time at the office to complete paperwork, etc. This customization may be accomplished by inputting a percentage over the normal number of visits an adjuster may make. This percentage may then be gradually reduced to zero (or the normal number of visits) over time to reflect the above situations.

It should be noted that the customizations described with respect to input screen 400 are only exemplary and any of the aspects of the model may be customizable for the individual insurance company and the various workflows of the individual insurance company. It should also be noted that the customizations are described with reference to the adjuster sub-models, but the customization may be applied to any field visit personnel (e.g., builder, surveyor, etc) or any function within the process flow that has an associated sub-model.

As described above, the model may allow for sub-models to be executed and used for input into the model. The following will provide several examples of a sub-model, whose input is used for the model. As shown in FIG. 4, the selected FNOL period 408 is 15 minutes. A sub-model may be implemented that probabilistically analyzes the arrival of claims in the selected period (e.g., 15 minutes). The output of this sub-model may then be used as the input to the model to account for the differing time frames selected for the model (e.g., 1 week) and the FNOL step (e.g., 15 minutes).

To provide context for the purpose of this exemplary sub-model, it may be considered that a call center that receives the claims may be open daily from 8:00 am-8:00 pm. The call center needs to be staffed during these twelve hours. However, it may be that the calls received by the call center on any given day do not exhibit a uniform distribution. For example, there may be a low number of calls between 8:00 am-9:00 am (e.g., people are commuting, taking children to school, etc.) during this time period. Whereas, there may be a much larger number of calls between 12:00 pm-1:30 pm that corresponds to lunch hour when people have time to call to submit the claim. Further, the calls between different days may also fluctuate. For example, it may be that more calls come in on a Monday than a Thursday. Also, more calls will likely come in during the first week after the CAT event than in the second week, etc. It should be apparent that all these conditions affect the staffing needs for the call center. It should also be apparent that understanding how many calls are going to come in during week 1, week 2, etc. after the CAT event is not granular enough to allow the insurance company to effectively staff the call center. Thus, in the example of FIG. 4, the insurance company desires to know the level of calls received during 15 minute time periods to provide the necessary level of detail.

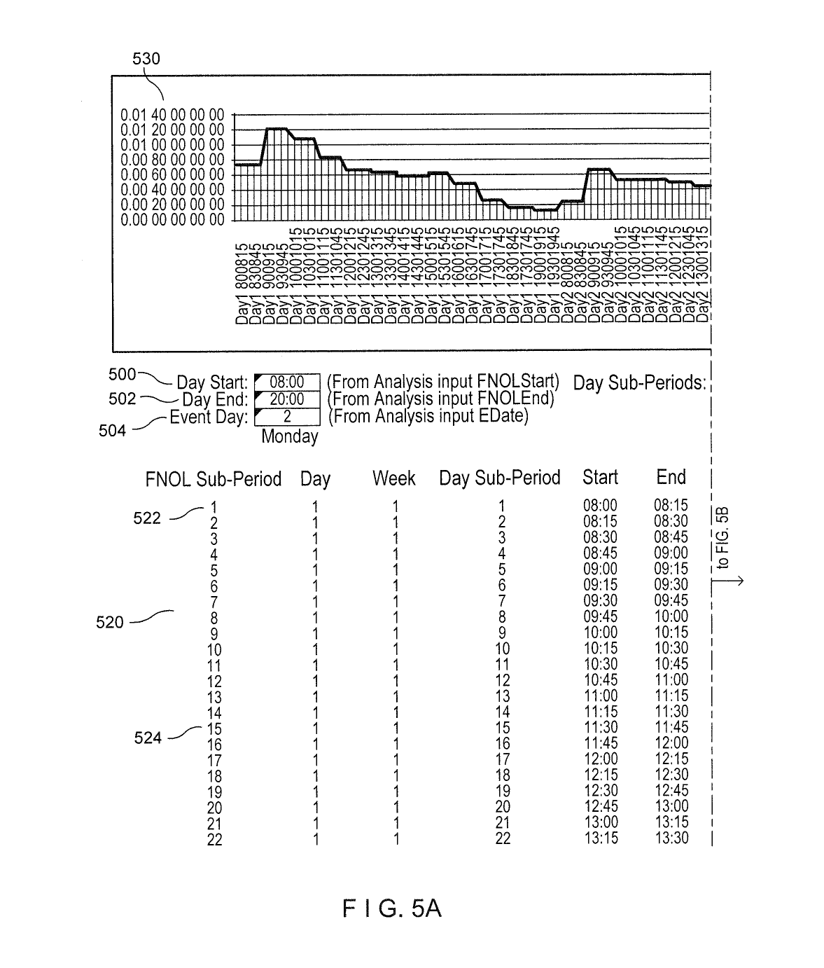

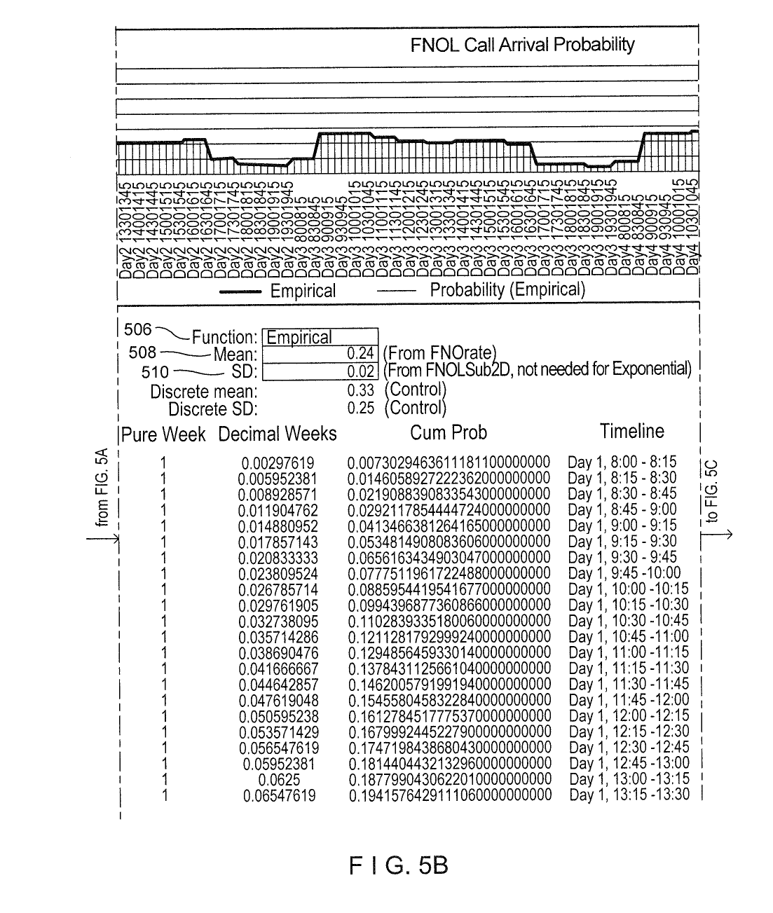

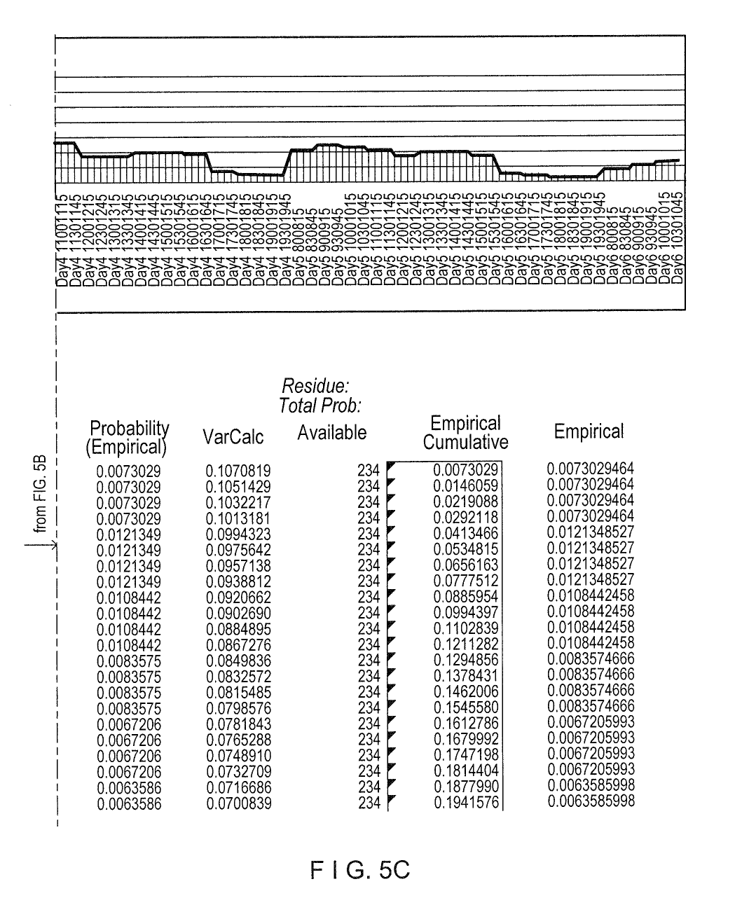

FIG. 5 shows exemplary data and information that may be used to determine the claims presentation in 15-minute periods. In this example, the user may select various parameters to be used in generating the sub-model. For example, the day start 500, the day end 502 and the event day 504. As described above, this example indicates a day start 500 of 8:00 am and a day end 502 of 8:00 pm, resulting in 48 sub-periods per day (12 hours×4 sub-periods per hour).

The user is then allowed to select a function 506, a mean 508 and a standard deviation 510. In this example, the user has selected a function of “empirical.” This refers to empirical data for previous events. That is, the insurance company (or other insurance companies) may have data indicating how calls were received for previous events and the distribution of these calls for the previous events. Based on this data, the sub-model may generate a statistical distribution for the receipt of the calls. The mean 508 and the standard deviation 510 may be used to modify this distribution across a selected standard deviation around a selected mean.

It is noted that there may be situations where empirical data does not exist or the user does not want to use empirical data because they do not believe it is relevant to the situation that is being modeled. In such cases, the user may select a different function 506. Examples of different functions include an exponential distribution, a gamma distribution, a lognormal distribution, a normal distribution, etc. The mean 508 and the standard deviation 510 may also be used to modify these distributions.

The sub-model may then generate the probabilistic data to model the call arrival based on the input parameters 500-510. The probabilistic data is shown in both table form 520 and graph form 530 in FIG. 5. As shown in table 520, each entry corresponds to a 15-minute sub-period, e.g., entry 522 corresponds to sub-period 1 of day 1 of week 1 for the time 08:00-08:15, entry 524 corresponds to sub-period 15 of day 1 of week 1 for the time 11:30-11:45, etc. It should be understood that the view of FIG. 5 only shows the first 22 entries, but the table 520 will continue for all the selected sub-periods. In this example, the sub-periods corresponding the selected duration of 5 weeks for the FNOL step as shown in table 420 of FIG. 4. The graph 530 shows the probabilistic data in graphical form. This probabilistic data and information may then be used to generate claims arrival information that may then be used as an input into the model for the running of the scenario. An example of the claims arrival information will be provided below.

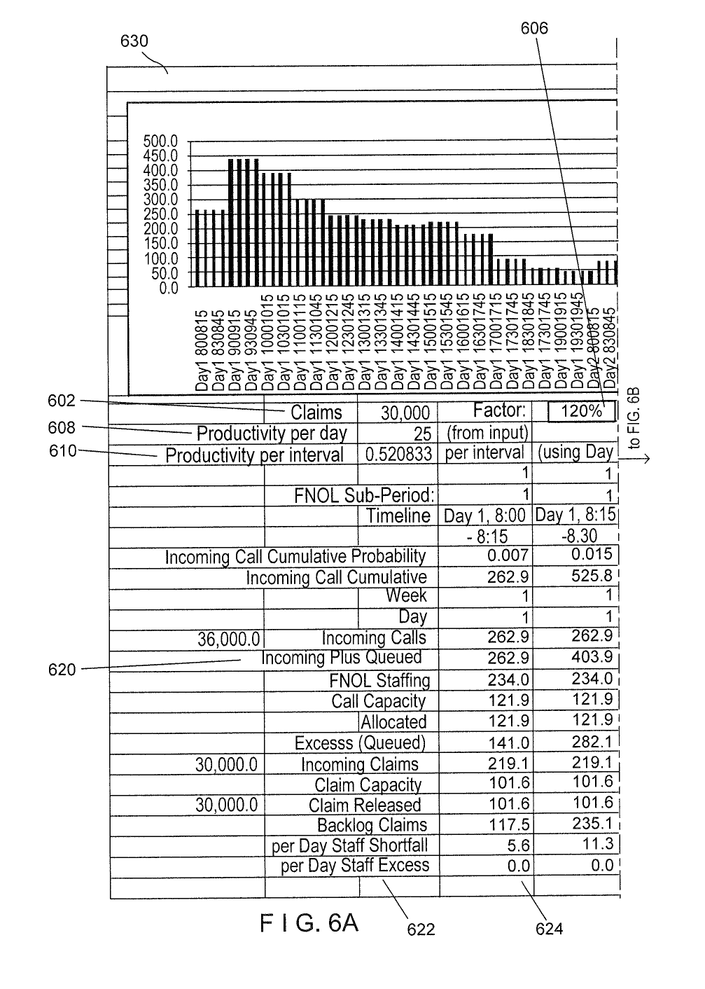

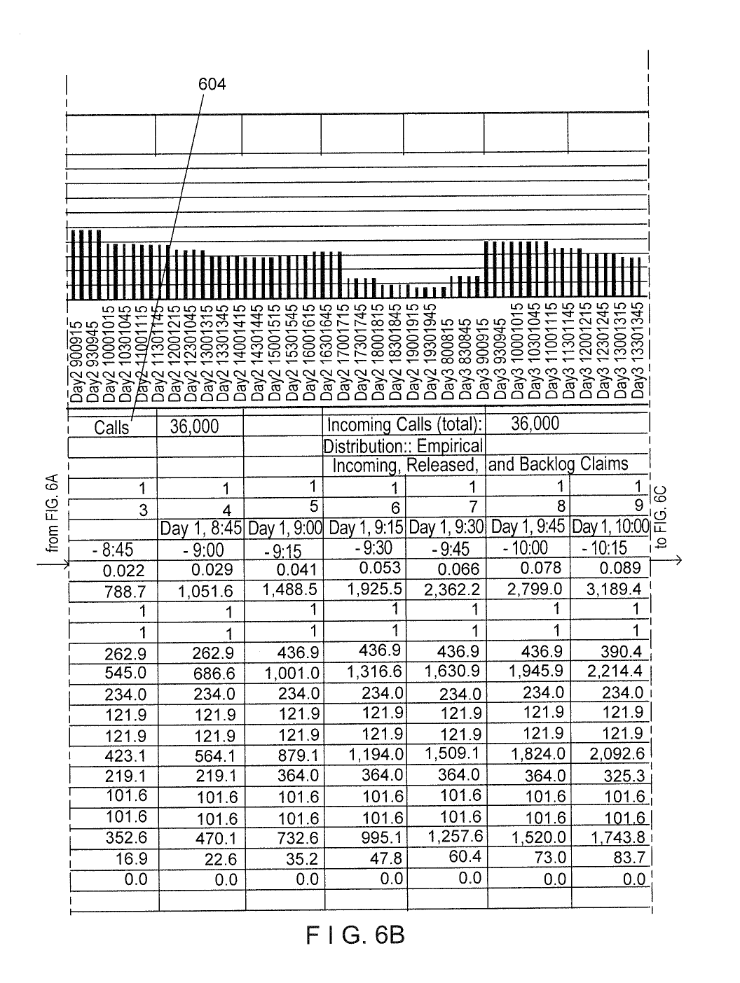

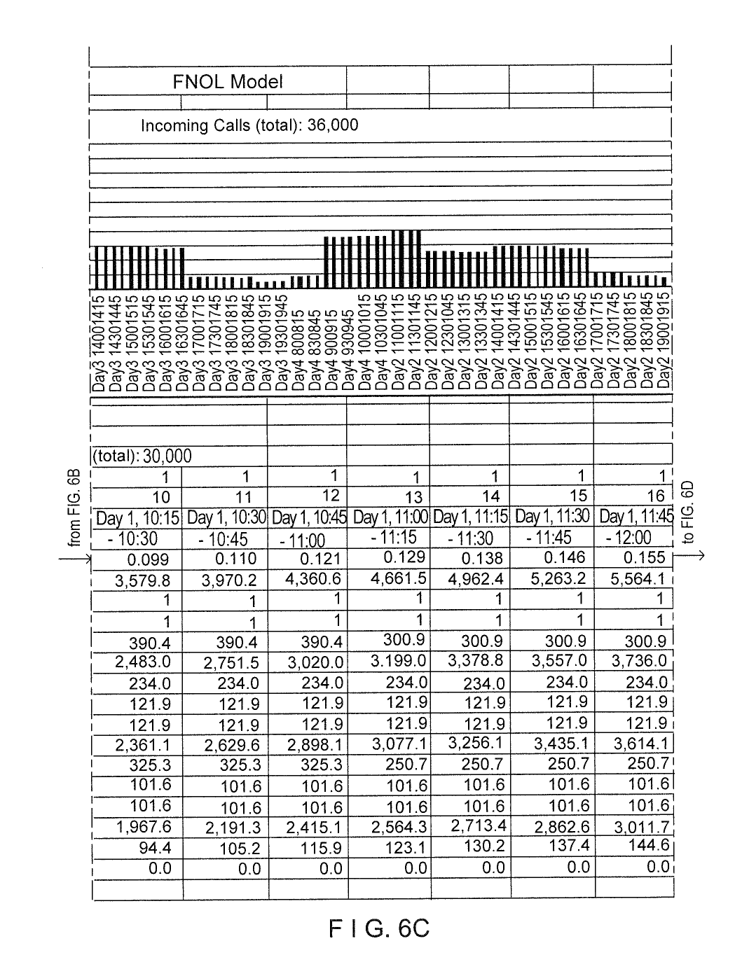

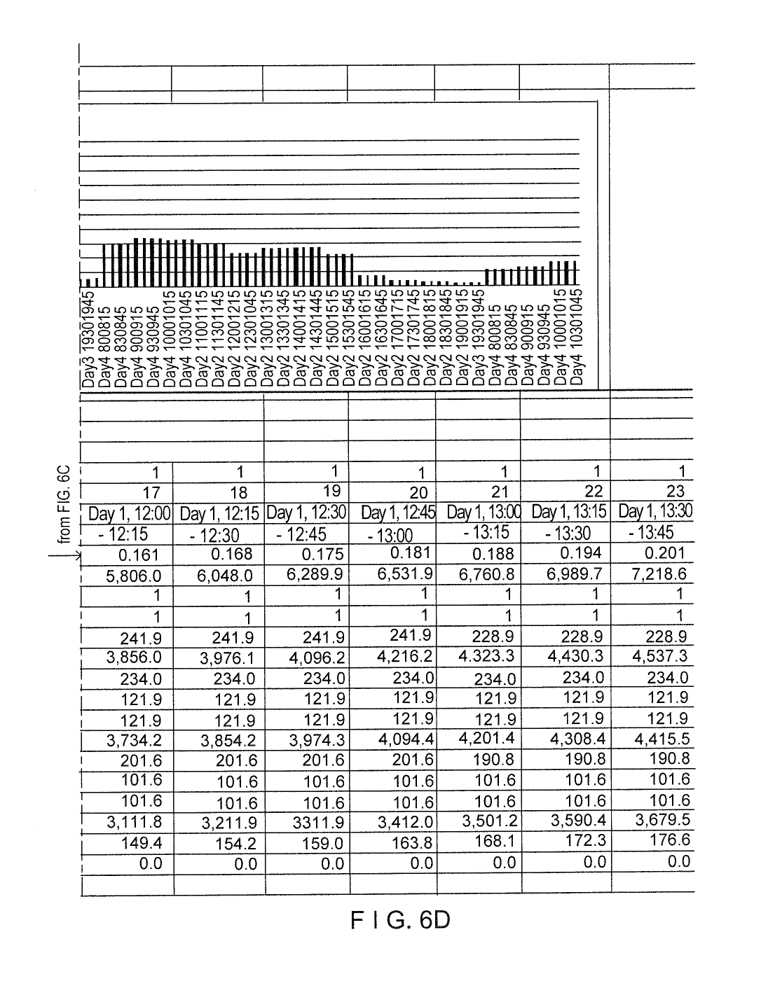

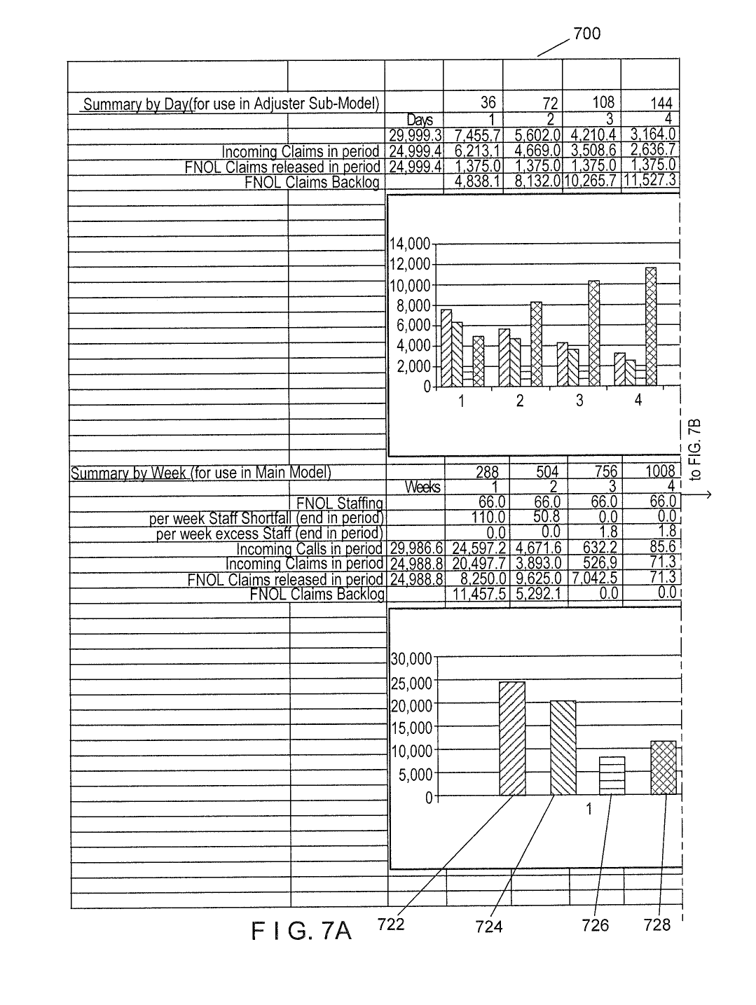

FIG. 6 shows an example of the call distribution/claims arrival for the 15-minute intervals using the probabilistic data and information from FIG. 5. In this example, it is assumed that the insurance event will generate 30,000 claims 602 based on the call center receiving 36,000 calls 604 (e.g., calls equal a factor 606 of 120% of claims). Those skilled in the art will understand that each arriving call is not necessarily a new claim, because persons may call multiple times, may call the wrong insurance company, etc. The number of claims presented is a subset of the number of calls received. However, the call center needs to handle all the incoming calls regardless of whether the call includes an actual claim.

The sub-model also includes a productivity input 608 that indicates the number of calls that an operator may handle in a day. The productivity per interval 610 data is determined based on the productivity per day divided by the number of periods per day, (in this example, 25 calls per day/48 sub-periods per day=0.520833).

The probabilistic data from FIG. 5 is then applied to the input parameters of FIG. 6 and the number of calls/claims that are received in each sub-period of the sub-model duration is determined. Again, the data is shown in both table form 620 and graph form 630. The column 622 of the table 620 shows the type of data that is provided by the sub-model for each of the sub-periods. The column 624 shows the data for the first sub-period, e.g., sub-period 1 is 08:00-08:15 of day 1. This calculated call/claims information may then be input into the model to run the simulation.

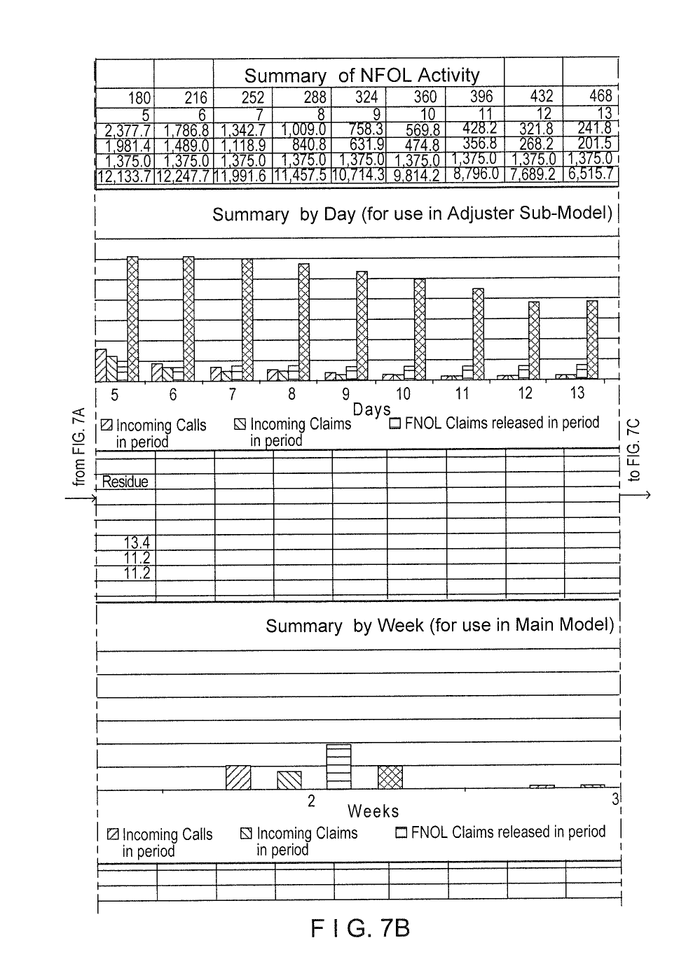

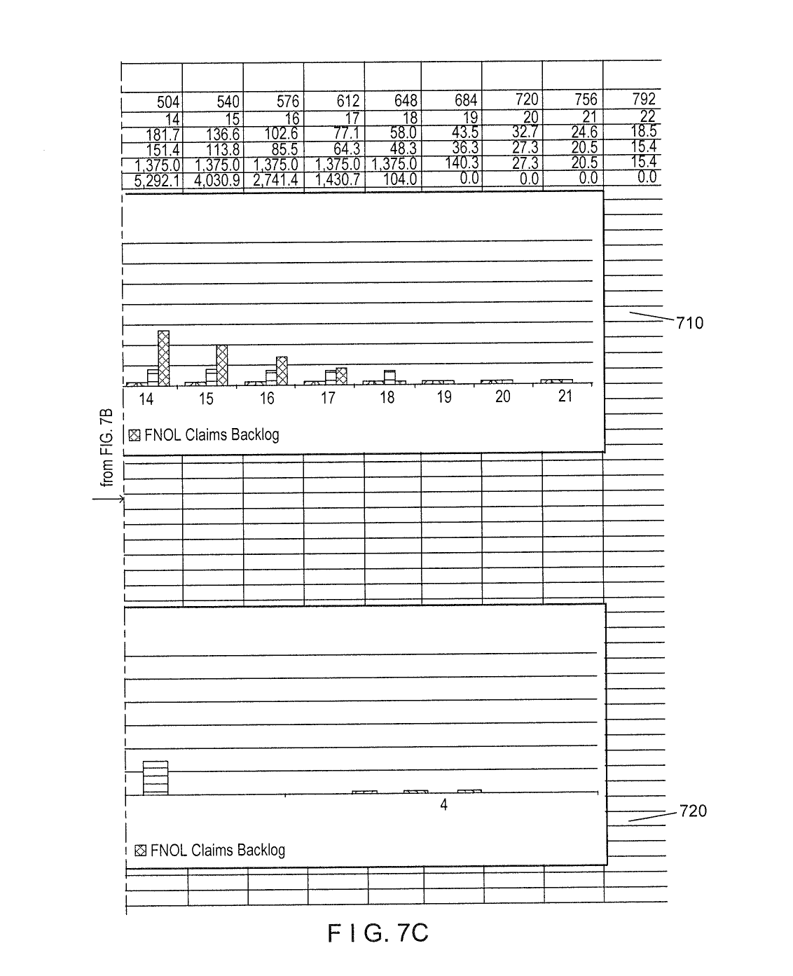

FIG. 7 shows a view 700 that transitions the 15-minute data of FIG. 6 into daily and weekly intervals that may also be input into the model. In this example, the graph 710 and the accompanying data show the claims on a daily basis and the graph 720 and accompanying data show the claims on a weekly basis. The data in graphs 710 and 720 for each relevant time period is shown as the number of incoming calls 722, the number of incoming claims 724, the number of claims released 726 and the number of claims in backlog 728. This presentation is only exemplary and the data may be presented to the model in different manners.

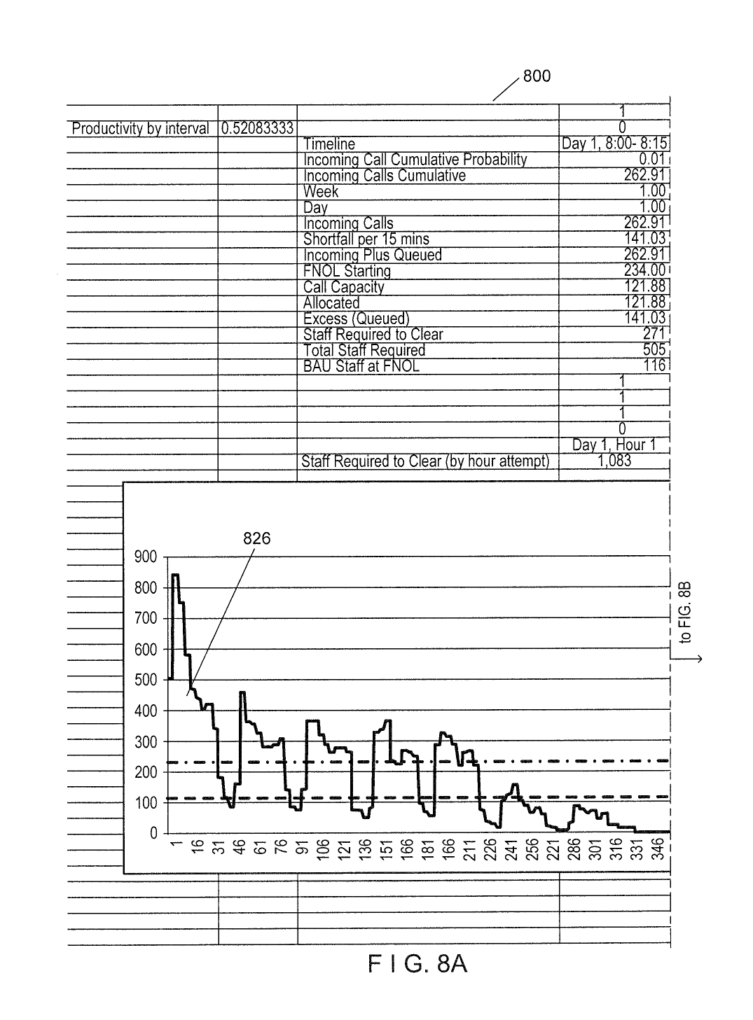

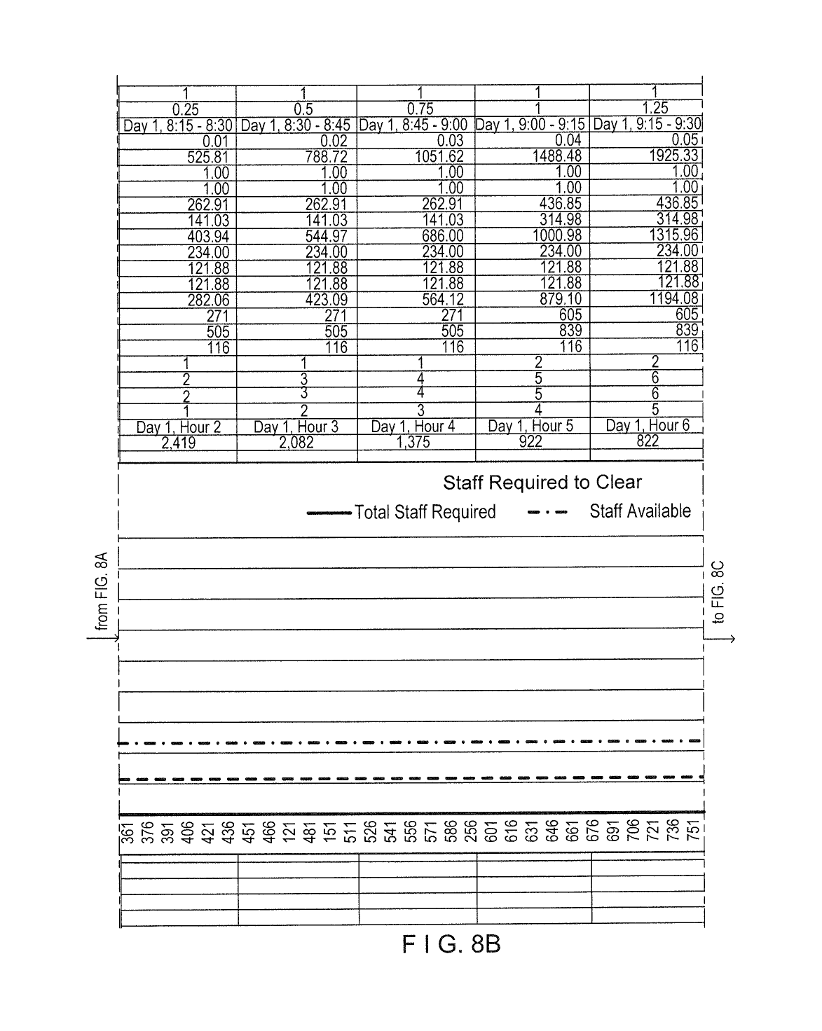

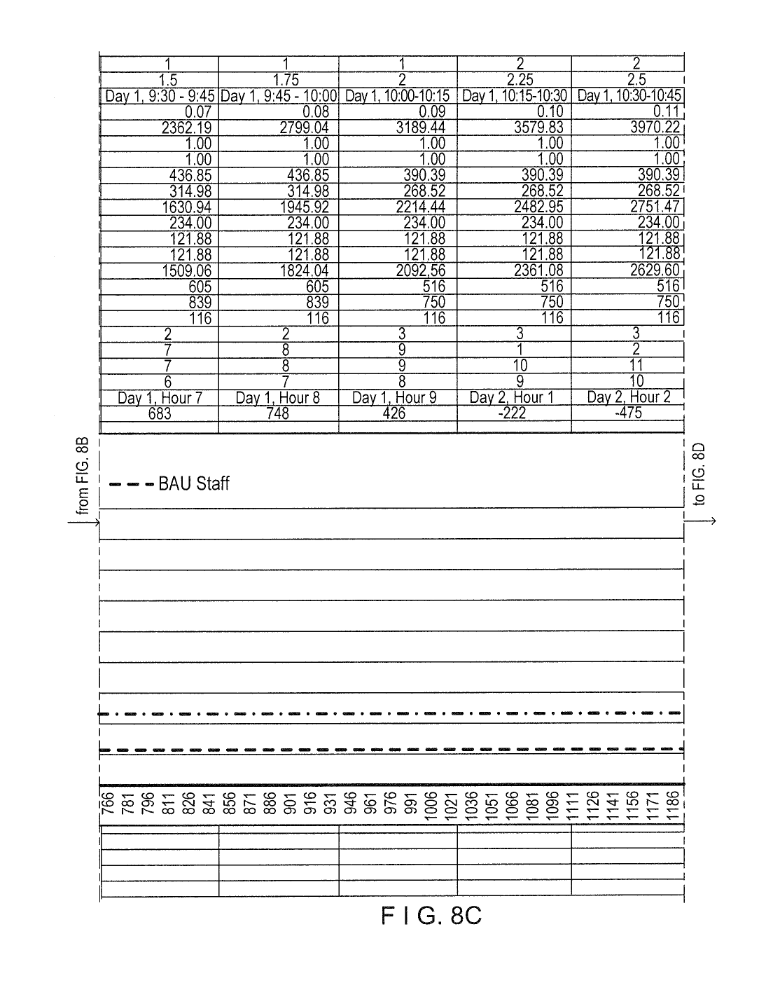

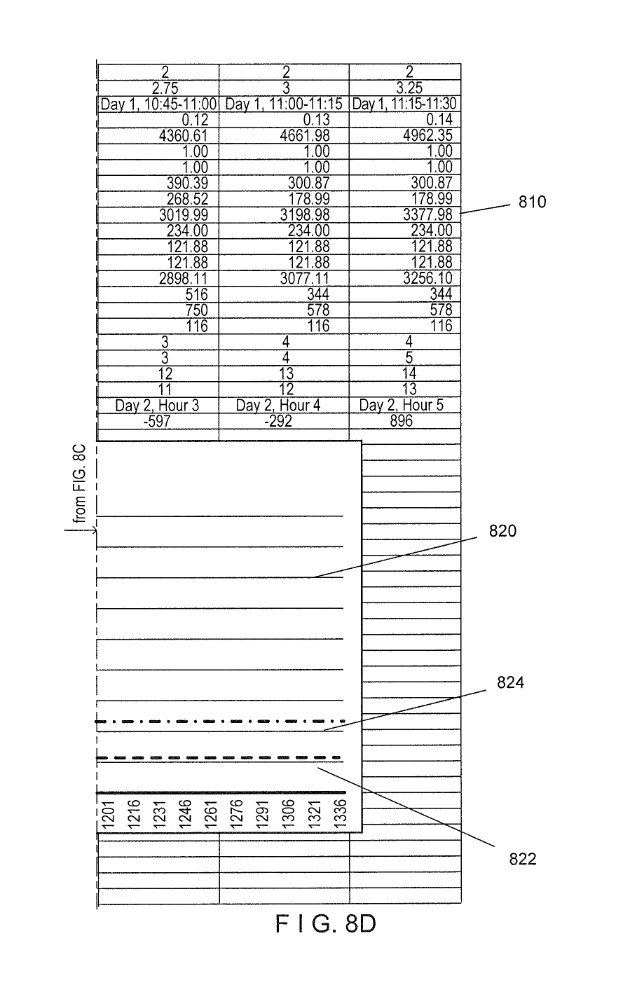

FIG. 8 shows a view 800 that provides an analysis of the staff required to clear the possible FNOL backlog as determined by the sub-model. It is noted that the backlog is referred to as a possible backlog because as this is a model output, there is no guarantee that an actual backlog will occur. Rather, based on the individualized claims flow, it is possible that a backlog may develop and this FIG. 8 shows a possible solution should such a backlog occur. The table 810 presents the call/claims information as determined by the sub-model for the sub-periods. The information presented by table 810 is similar to the information presented in table 620 of FIG. 6. The graph 820 shows the number of staff required to clear the possible backlog with the number of staff being displayed on the vertical axis and the sub-period being displayed on the horizontal axis. The first line 822 shows the normal staffing of the call center. In this example, the normal staff is approximately 110 persons. The second line 824 shows the available staff for the call center. In this example, the available staff is approximately 220 persons. The third line 826 shows the number of staff actually needed to handle the expected calls based on the distribution of calls as determined by the sub-model. This graph 820 shows which sub-periods require staffing beyond the clients ability to ramp up with the available staff. Thus, FIGS. 5-8 show an example of an FNOL step 110 sub-model.

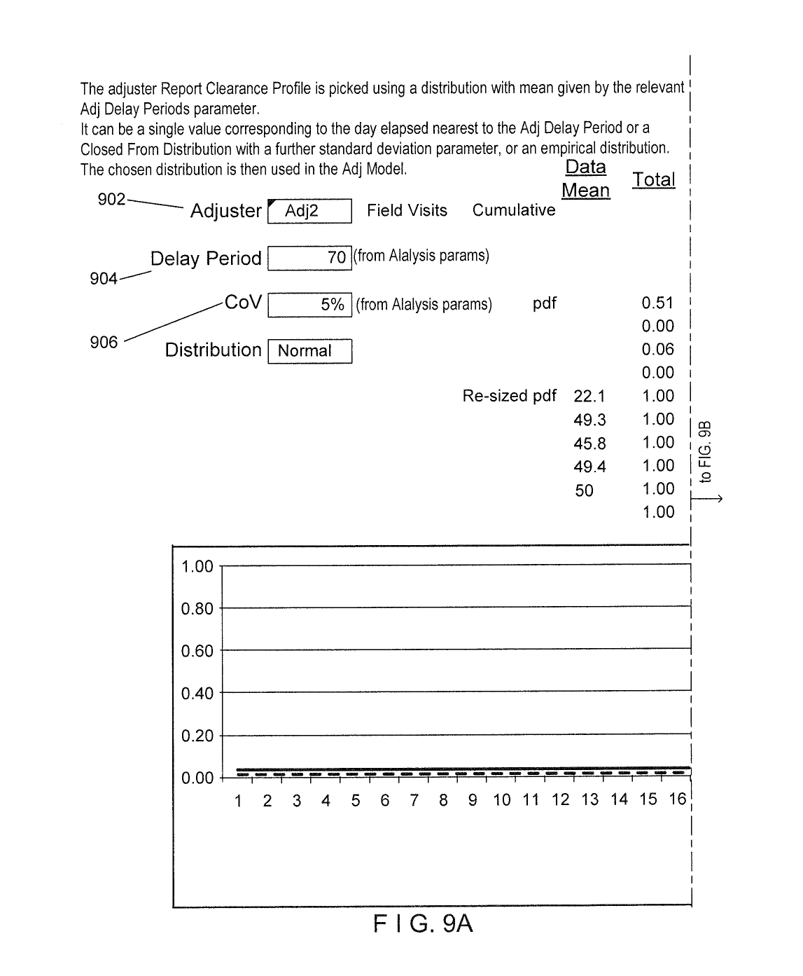

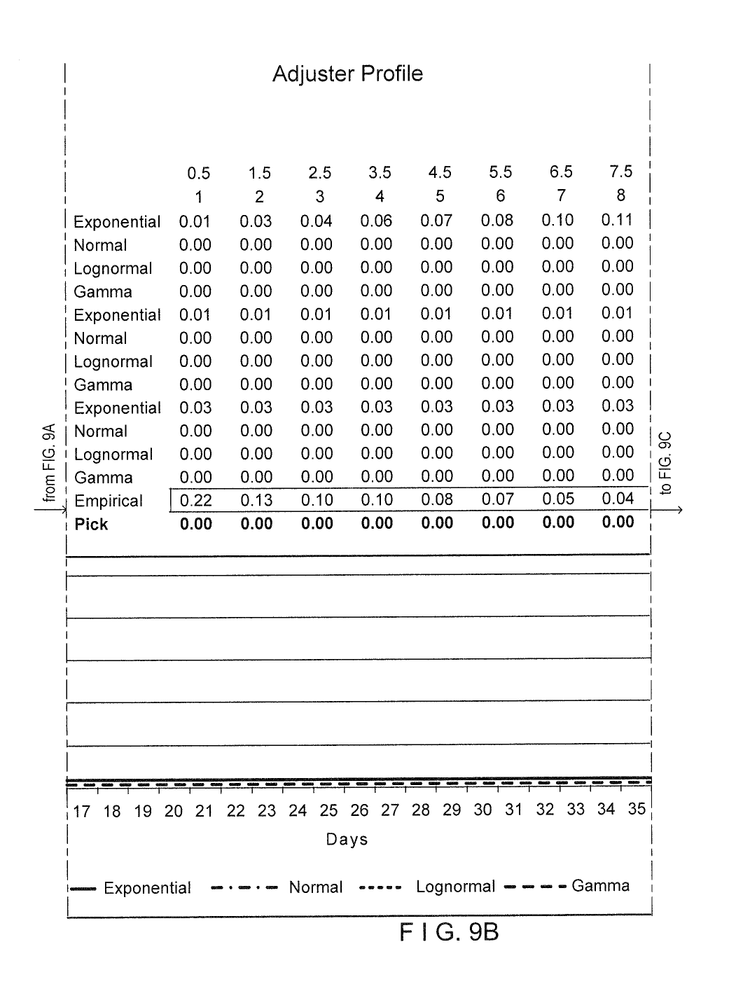

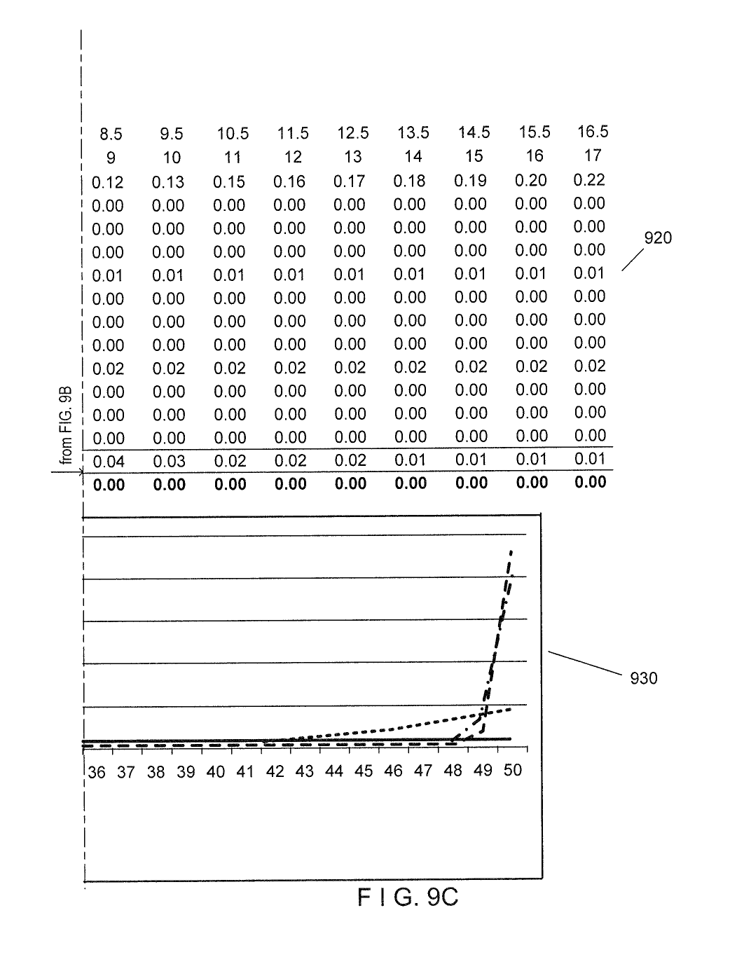

FIGS. 9-11 provide a further example of an adjuster sub-model. As described above for the FNOL step 110, it may be advantageous to provide a finer granularity for the visit step 120. In this example, the selected granularity for the adjusters of the visit step 120 was selected as one (1) day s shown by adjuster period 410 selection of FIG. 4. Thus, the adjuster sub-model will provide data input into the model based on the selected adjuster period 410.

FIG. 9 shows the data and information for the variations of claims handling by an adjuster for each of the workflows. This example is showing a distribution for an adjuster based on the adjuster field visit sub-model which is shown as Adj2 in table 420 of FIG. 4 and field 902 of FIG. 9. Additional parameters such as an adjuster delay period 904 and a coefficient of variation (CoV) 906 may be entered in the sub-model for the generation of the probabilistic data to be used for the sub-model. As described above for the claims intake, the field visit data can be empirical or follow a predetermined distribution such as lognormal, exponential, gamma, etc. This type of sub-model allows consideration of empirical findings that include the fact that average aging down each workflow does not take into account the variations that occur because of claim complexity. In other words, complex high value claims have longer life cycles and a simple average of the lifecycles does not adequately address this issue. Thus, similar to FIG. 5, FIG. 9 shows the probabilistic data for the expected field visit information for the adjusters. This probabilistic data is presented in both table form 920 and graph form 930.

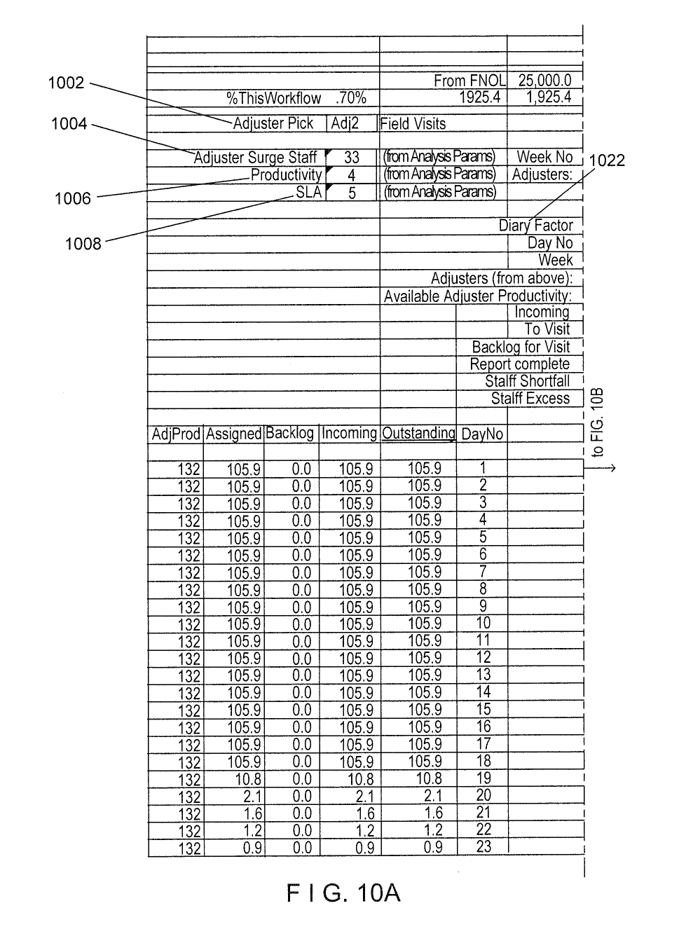

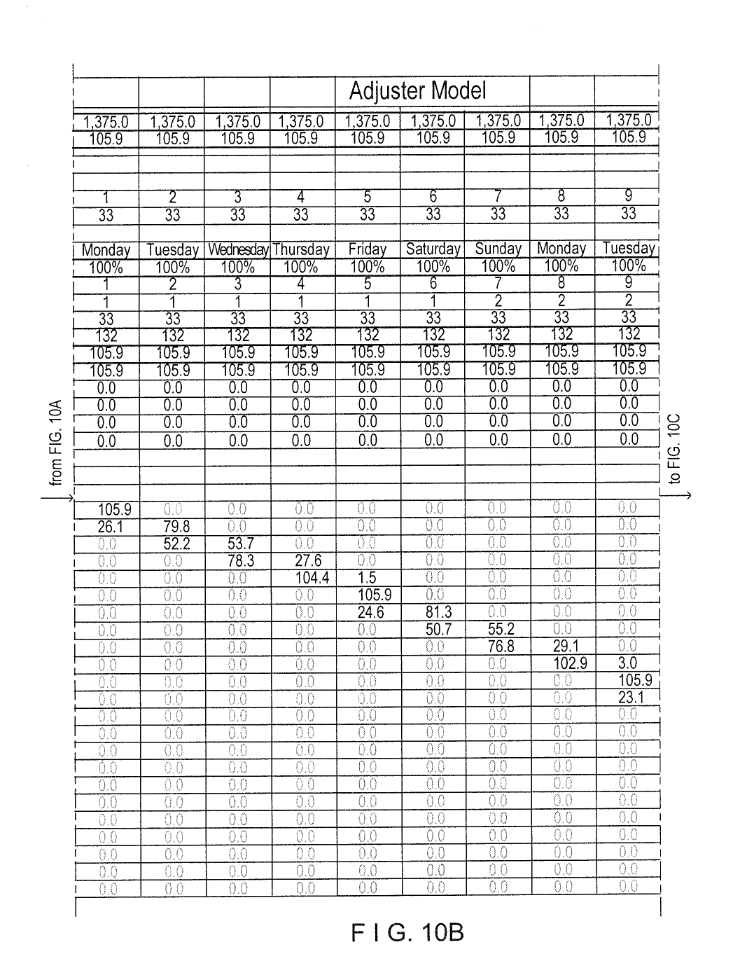

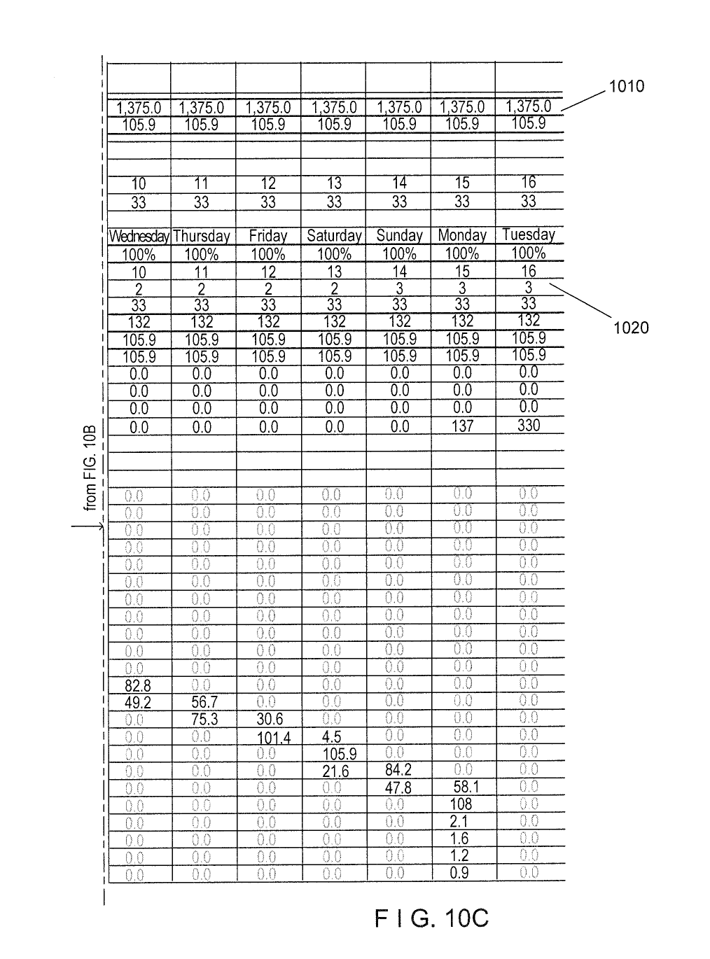

FIG. 10 shows an example of the adjuster production based on the data and information from FIG. 9. Again, the results shown in FIG. 10 is for the execution of the sub-model based on the probabilistic data generated as shown in FIG. 9 for the filed visit sub-model Adj2 as shown in table 420 of FIG. 4 and in field 1002 of FIG. 10. Additional input parameters are shown as the number of adjusters 1004 (e.g., 33), the productivity 1006 of the adjusters (e.g., 4 visits per day) and the Service Level Agreement (SLA) 1008 for the adjusters (e.g., 5 committed contractual visits per day). These parameters and the probabilistic data from FIG. 9 are then used to generate the adjuster sub-model input for the model.

In the table 1010, it is shown how many field visits will be generated per day from the FNOL. In this example, it is shown that the FNOL generates 105.9 field visits every day. Those skilled in the art will understand that the data presented in FIG. 10 is only exemplary and used for illustrative purposes. The table 1020 shows the adjuster information on a day-by-day basis. The information that may be provided by the sub-model is shown in column 1022 and the values are shown for each day in the subsequent columns. As shown in table 1020, based on the number of adjusters and the projected field visits per day, the adjusters will be able to handle the field visits each day that are generated by the FNOL. That is, 33 adjusters having a capacity of 4 visits per day results in 132 visits which is more than the projected 105.9 field visits generated by the FNOL. Again, this data is only exemplary and the actual data when the sub-model is run may show there are days when the number of required field visits exceeds the capacity of the adjusters.

One of the advantages of using the adjuster sub-models is that the sub-model allows for the recognition that visiting adjusters are able to take claims from the FNOL function at a greater rate than their daily production. That is, their production rate in the main model may only be 1 visit per day. However, the sub-model recognizes that the adjuster can take visits as diary management items and may spread the visits in time across either a contractual SLA or at the customer's request or as a result of access. The information from the adjuster sub-model may also be input into the main model as with the FNOL sub-model information.

As shown in table 420 of FIG. 4, there are three adjuster sub-models labeled as Adj2, Adj3 and Adj4 in this example. The examples provided in reference to FIGS. 9 and 10 related to the Adj2 field visit sub-model. Those skilled in the art will understand that there may be corresponding information that is input and derived for the other adjuster sub-models Adj3 and Adj4. This information may also be an input to the main model. In addition, as described above, the sub-models shown in FIG. 4 are only exemplary and there may be additional sub-models for the same steps or for the other steps.

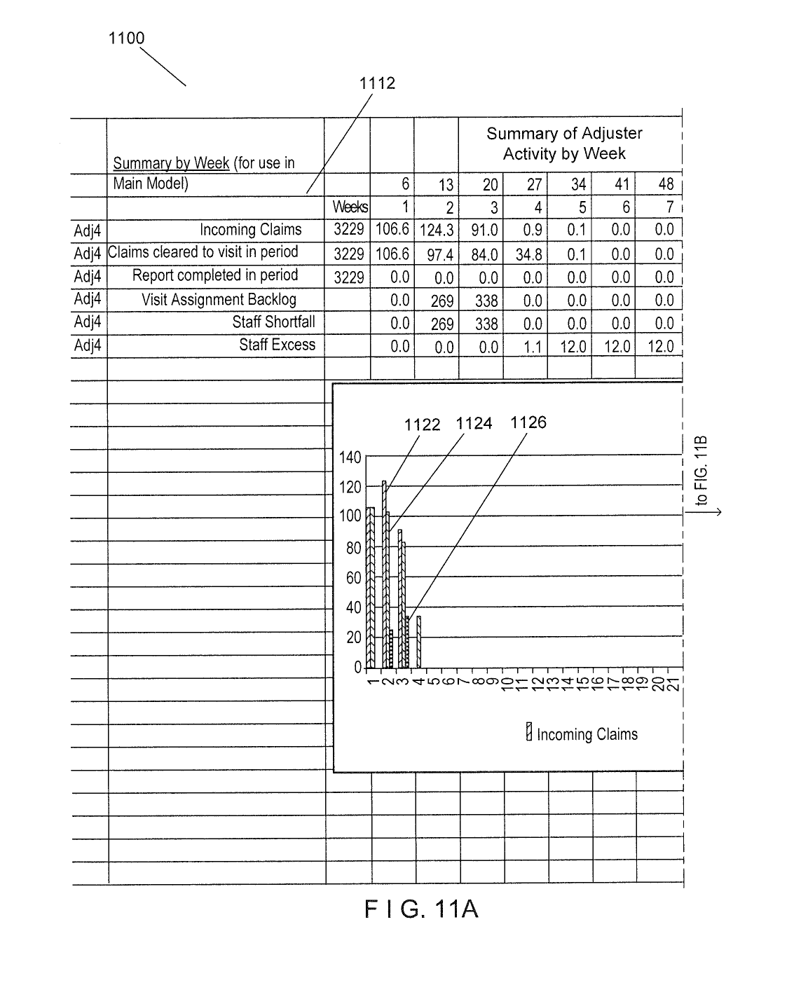

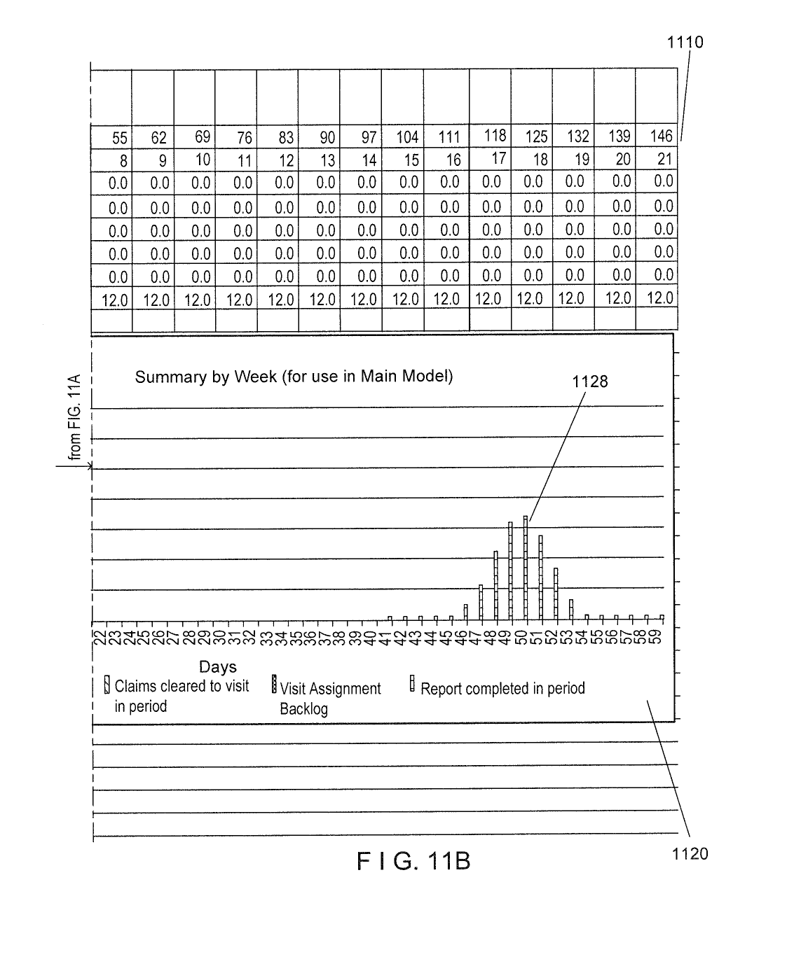

FIG. 11 shows the summary view 1100 of an adjuster sub-model on a weekly basis. The weekly summary is based on the fact that the exemplary main model is a weekly model. If, for example, the main model was a bi-weekly model, the summary view 1100 may be formatted as a bi-weekly view. It is also noted that the summary view is not for the adjuster field visit sub-model Adj2 shown in FIGS. 9 and 10, but the summary for adjuster major loss sub-model Adj4. Again, this sub-model may also generate information in the manner described for sub-model Adj2. The data is summarized on a weekly basis in the table 1110 with column 1112 showing the type of information generated by the sub-model and the subsequent columns showing the information for each of the weeks of the sub-model. In this example, the table 1110 is only showing weeks 1-21, but as shown in table 420 of FIG. 4, the adjuster major loss sub-model runs for a period of 59 weeks.

The entire 59-week period is shown in the graph 1120. In this example, the graph 1120 shows the summary of data in graphical weekly format including, the number of incoming weekly major loss claims 1122, the number of major loss claims cleared to visits 1124, the visit assignment backlog 1126 and the reports completed 1128. As described above, this information is specific to the adjuster major loss sub-model and the other adjuster sub-models will include different weekly summary information.

The discussion corresponding to FIGS. 4-11 will provide those skilled in the art an understanding of the processes and functionalities related to sub-models. The output of these sub-models may then be used as input to the main model.

Returning to FIG. 2, each of these inputs is entered into the simulator 240 that executes the model based on the inputs. There are two modes that the model can operate in, actual and predictive modes. In the actual mode, the insurance company's actual metrics are used to demonstrate the likely outcome of its operating parameters when faced with a series of scenarios. For example, given, the volume and monetary value of the claims presented, the model may provide, for example, the number of staff and its productivity, at each time interval, how long the response will take to settle all claims and what the cost will be to settle the claims. The actual mode provides a baseline starting point, to identify potential areas for improvement.

In the predictive mode, the model has the ability to fix or vary certain primary and secondary modifiers inputs. The variables are modified to predict the likely impact of varying response strategies. For example, how would on-site technology increase per head production and therefore improve the timeline and reduce cost. In reverse mode, the model would, for example, consider the length of time a client wanted a response to take and then inform the client what the resource requirements would be if they were to aspire to achieve this. This could demonstrate how the use of on-site technology might improve field visit production and with the same resource reduce elapsed time or meet the set requirement. By way of another example, it may be determined that a view of a varying threshold where claims are automatically settled without visits would be useful. The model would then increase/decrease on a sliding scale showing the effect on the elapsed time/resource required at each stage and overall cost.

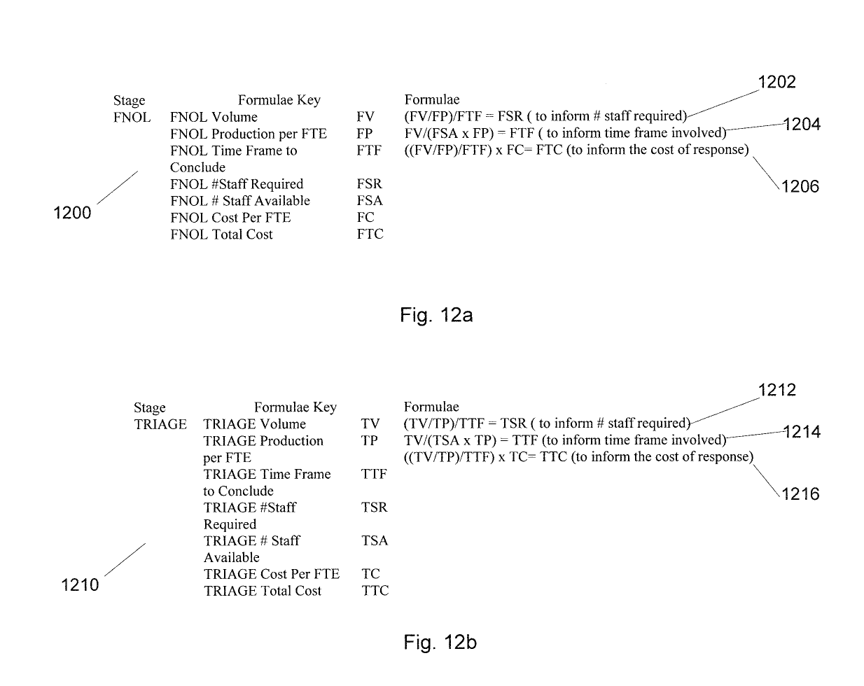

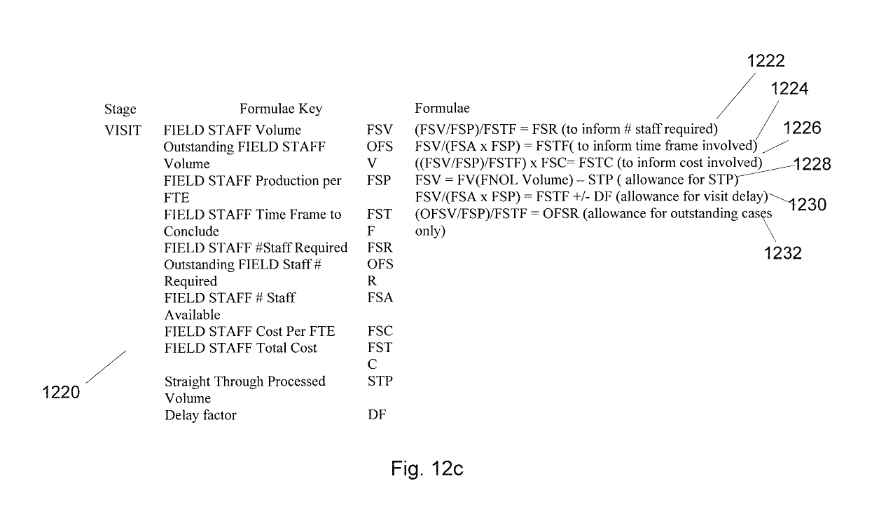

Part of the simulation is the calculation of various values using the inputs. FIGS. 12a-c show some example formulae that the simulator 240 uses to calculate these values. The example formulae are shown for the FNOL, Triage and Visiting Field Staff stages. However, those skilled in the art will understand that these formulae may carry through other steps including back office, recovery, although as the equations for the same format, these are not shown here. It should be noted that these formulae are only exemplary and it is not necessary to calculate these particular values. The exemplary embodiments do not rely on any particular formulae, but rather the way in which these link together to form the claims journey, and the way in which weighting factors are applied at each step of the way to affect the time-cost-resource. Examples of the links of the various parameters are provided in tables 300 and 390 that were described above.

FIG. 12a shows the exemplary formulae 1200 for the FNOL stage. In this example, the formulae 1200 calculate three different values for the FNOL stage. The first value 1202 is the number of staff required for the FNOL stage (FSR). The second value 1204 is the time to conclude the FNOL stage (FTF). The third value 1206 is the total cost of the FNOL stage (FTC). The formulae 1200 include the parameters that are used to calculate these values. It should be noted that the FSR and the FTF are influenced by the run rate. The model allows for each to be ramped up and down according to the intake rate. For example, it would not be in the interests of the insurance company to staff the maximum number of persons immediately if there is a two-week delay in claims being notified. At any stage of the process the elapsed time to settle can therefore be expressed as:

Elapsed Time=(Open Cases Untouched+Anticipated Further Input−Anticipated Closures)/Closure Rate

This is true of any stage but also if expressed at the highest level for the whole response taking into account all processes.

FIG. 12b shows the exemplary formulae 1210 for the triage stage. In this example, the formulae 1210 calculate three different values for the triage stage that correspond to the values calculated above for the FNOL stage. The first value 1212 is the number of staff required for the triage stage (TSR). The second value 1214 is the time to conclude the triage stage (TTF). The third value 1216 is the total cost of the triage stage (TTC). The formulae 1210 include the parameters that are used to calculate these values.

FIG. 12c shows the exemplary formulae 1220 for the Visiting Field Staff stage if a visit is deemed appropriate. In this example, the formulae 1220 calculate six different values for the visiting stage. The first value 1222 is the number of staff required for the visiting stage (FSR). The second value 1224 is the time to conclude the visiting stage (FSTF). The third value 1226 is the total cost of the visiting stage (FSTC). The fourth value 1228 is the field staff volume (FSV) for the visiting stage. The fifth value 1230 is the FSTF with a delay factor (DF) to allow for visit delays. The sixth value 1232 is the outstanding field staff required (OSFR) which allows for only outstanding cases. The formulae 1220 include the parameters that are used to calculate these values.

The field staff volume (FSV) requires adjustment from the overall volume to reflect any cases where a visit is not required and is straight through processed. For example if a percentage of claims or those below a certain threshold are simply settled then the FSV would be expressed as follows:

FSV=FV(FNOL Volume)−STP

In addition the time frame to conclude a visiting processed may be delayed by some factor such as access difficulties. Therefore, the time frame to conclude could be expressed as follows:

FSV/(FSA×FSP)=FSTF+/−DF

In seeking to measure the staff required going forward for visits at any point in time then the volume FSV requires adjusting to allow for only the outstanding cases remaining to be considered. This could therefore be expressed as follows:

(OFSV/FSP)/FSTF=OFSR

It can be seen where the model starts to run as a logic written to look at OFSV and OFSR+/−STP+/−DF would produce a diminishing return and a graph showing a ramp down in terms of staff required and elapsed time. If this were not the case it would show a static number of staff required from the start of the event through to the conclusion whereas in reality the insurance company should be able to withdraw staff at some point.

All of the above formulae can be expressed in terms of outstanding volume only. The logic can also carry through to simulate the requirements of a supply chain. If it is known at what point there is a requirement to oversee reinstatement then a similar set of formulae can be applied to a contractor network. Alternatively, the contractor resource may be applied to the model, including the volume of claims expected to go to the contractors.

As described above, similar formulae may be applied to the other stages of the claims journey. The static formulae are the same but expressed as individual to the staff, time, and production capability of that stage. A further area worthy of separate note however is the desire for the model to assess the triage stage further that produces an analysis dependent on the skills banding available versus the skill sets required. Where the volume was expressed as a volume per skills band and the staff available/required expressed as those in the corresponding bands this would produce the output required. For example there may be enough staff available in terms of numbers, but if the claims remaining outstanding are all high end complex matters then that set of staff will be required for longer and be more resource hungry than those at the lower end.

Thus, the exemplary embodiments include a dynamic model that looks at each stage and determines the output given a set of claims presented to it. For example, if there is a large volume of claims but many are low in value then this would automatically send claims down the non-visiting route. The model would determine less visiting staff would be required, but there would be pressure on the back office staff to handle such a large volume. As each claim is settled the model would also predict an accumulating claims cost both for the indemnity spend and the cost of response together and separately. This would allow the claim spend to be examined separately and strategies explored to determine if the cost of managing the response could be reduced.

As described above, the simulator 240 may be run in two different modes, actual and predictive. However, these modes may be used for different use cases. For example, a first use case may be a planning use case where both actual and predictive modes are used to anticipate events and strategize/plan against output. In a second real-time use case, there may be live consultation with an insurance company while an event is occurring. For example, during Sandy, an analysis may be issued to reduce adjuster visiting times. The model would indicate effect on workload, elapsed time and resource required to fulfill, with the resultant cost. In a third retro use case, there may be a look back at an actual response and an analysis of what went well and what did not. In a final example use case, an annual health check may be performed to assess response capability, taking into account changes that have taken place (e.g., exposure, available resources) that materially affect an insurance company's operational ability to respond.

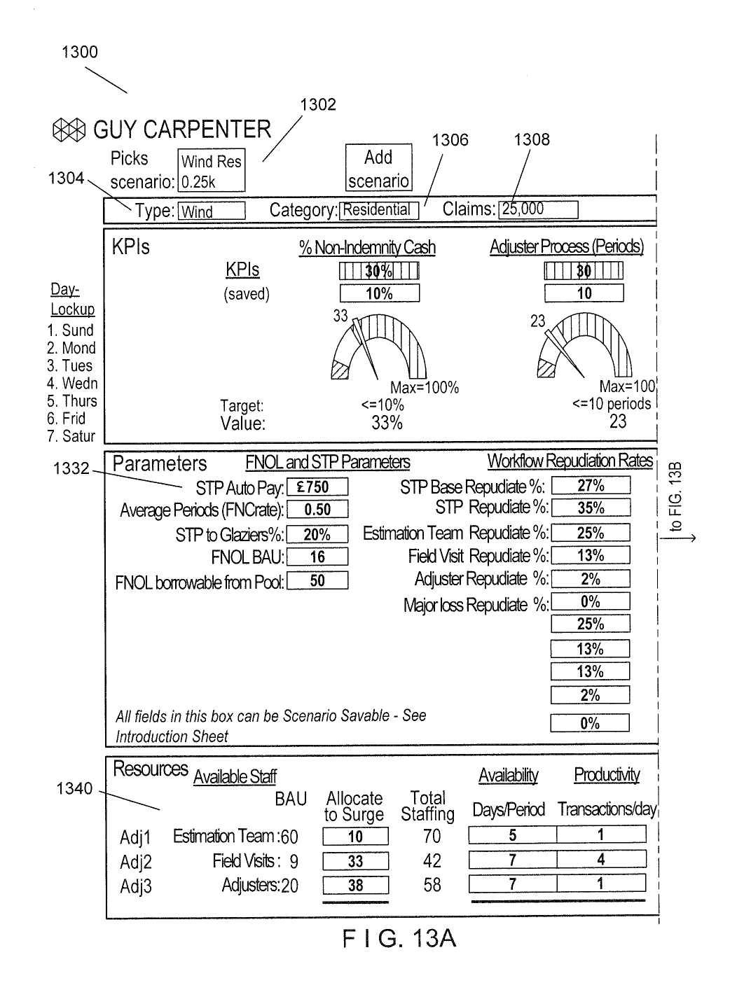

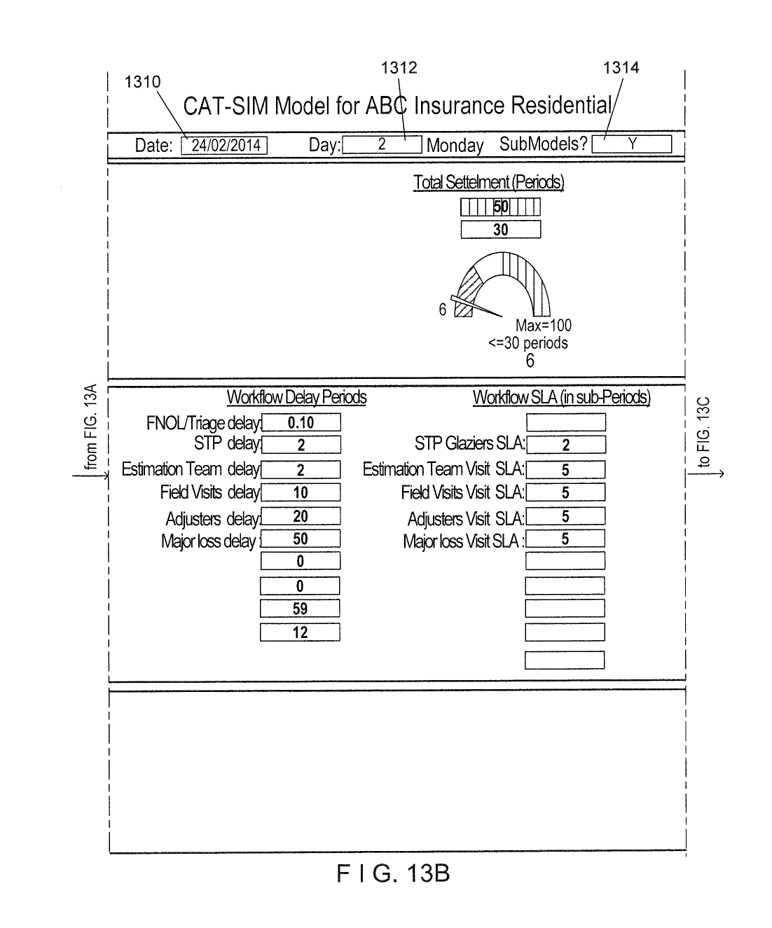

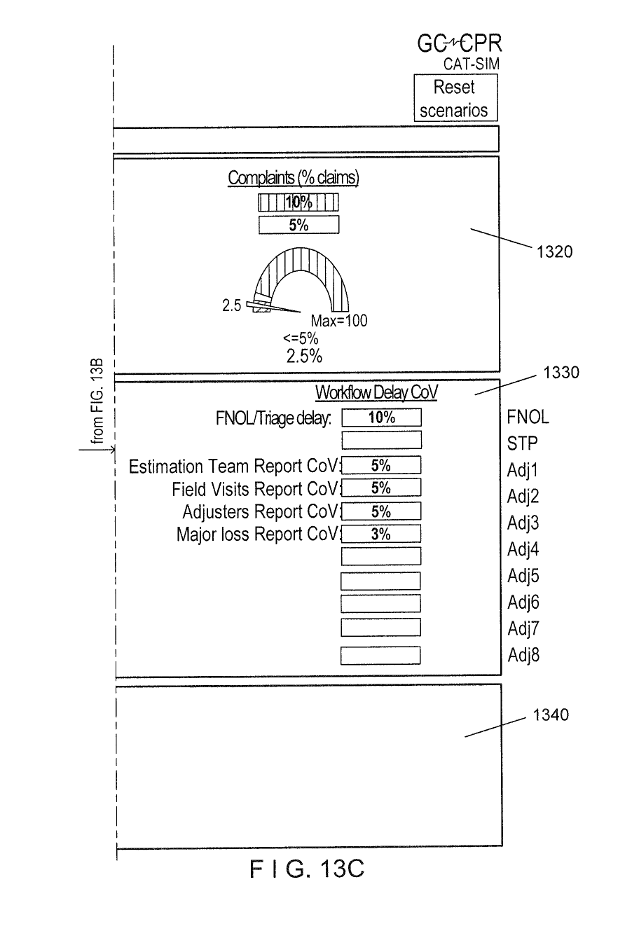

After the simulator 240 runs the model, there may be a series of outputs 250 that may be presented to the insurance company. The following provides a description of several exemplary outputs. However, those skilled in the art will understand that the outputs may be presented to the insurance company in a different manner. FIG. 13 shows a first exemplary output 250 in the form of a dashboard view 1300 that summarizes the findings for the given CAT response plan and scenario. The dashboard view 1300 allows the insurance company to visualize the results for the client's CAT plan and response strategy. While the exemplary dashboard view 1300 shows a single screen, there may be multiple screens depending on whether multiple CAT plans exist within an organization for different perils and geographic territories.

The aim of the dashboard view 1300 is to provide a single look of the overarching recommendations, which can then be discussed interactively with the executive team or operational teams. This dashboard view 1300 may be compatible with different display technologies such as tablets, phablets, laptops, desktops, etc. In addition, different dashboard views may be presented for different audiences (e.g., the executive team may be presented a different dashboard view from the operational teams). The dashboard view 1300 may also be dynamic to focus the insurance company on the most pertinent outputs depending on where the focus of attention/stress is required.

The dashboard view 1300 shows that a particular scenario 1302 has been selected based on the simulation that has been run. In this example, the scenario is named “Wind Res 25k” based on the parameters of type 1304 “Wind,” Category 1306 “Residential” and claims 1308 “25,000.” It should be clear from these parameters that this scenario is a wind event that results in 25,000 residential claims. Additional parameters that may be set for the scenario is the date 1310, the day of the event 1312 and whether sub-models have been considered 1314. As described in detail above, this scenario could be for the actual mode or the predictive mode.

The dashboard view 1300 also includes multiple areas 1320-1340 that show different information for the scenario. In the first area 1320, key performance indicators (“KPIs”) are shown. These KPIs are shown in both numeric and graphical format to provide an indication of any issues or potential issues to the user. For example, the first KPI is identified as “% Non-indemnity Cash.” The target value for this KPI is <=10%, but it is running at 33%. The graphical portion of this KPI indicator shows that this actual value is running in the “red.” For example, less than or equal to the target value may be colored green, slightly above the target value may be colored yellow and substantially above the target value may be colored red. This provides the user, at a quick glance, an indication of problem areas.

The second area 1330 shows the different parameters for the scenario, while the third area 1340 shows the resources available for responding to the scenario. Again, the parameters and resources for the scenario are only exemplary. However, it should be clear that these parameters and resources may be changed to allow the user to see how the scenario may be changed when alternative parameters are used. To provide a specific example, the second area includes a parameter STP Auto Pay 1232. The STP Auto Pay parameter 1232 is a parameter that indicates that all claims that are less than this value qualify for STP. For the current scenario, this parameter 1232 is set to a particular value. A user may decide to change this value to see how this changes the response.

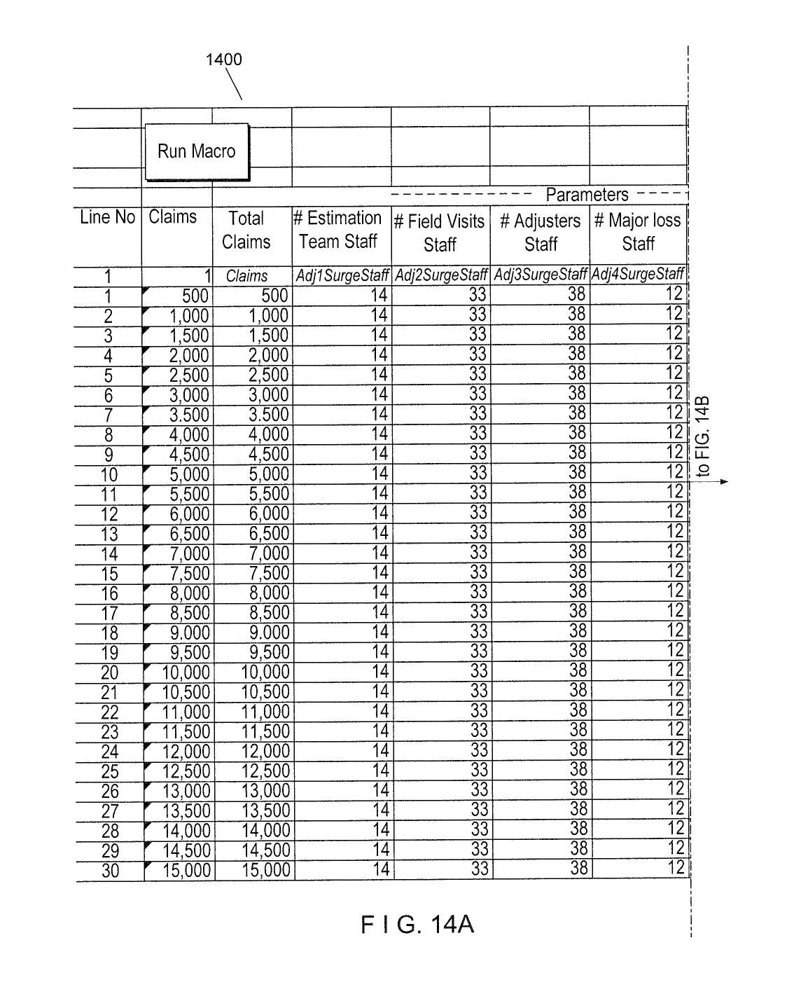

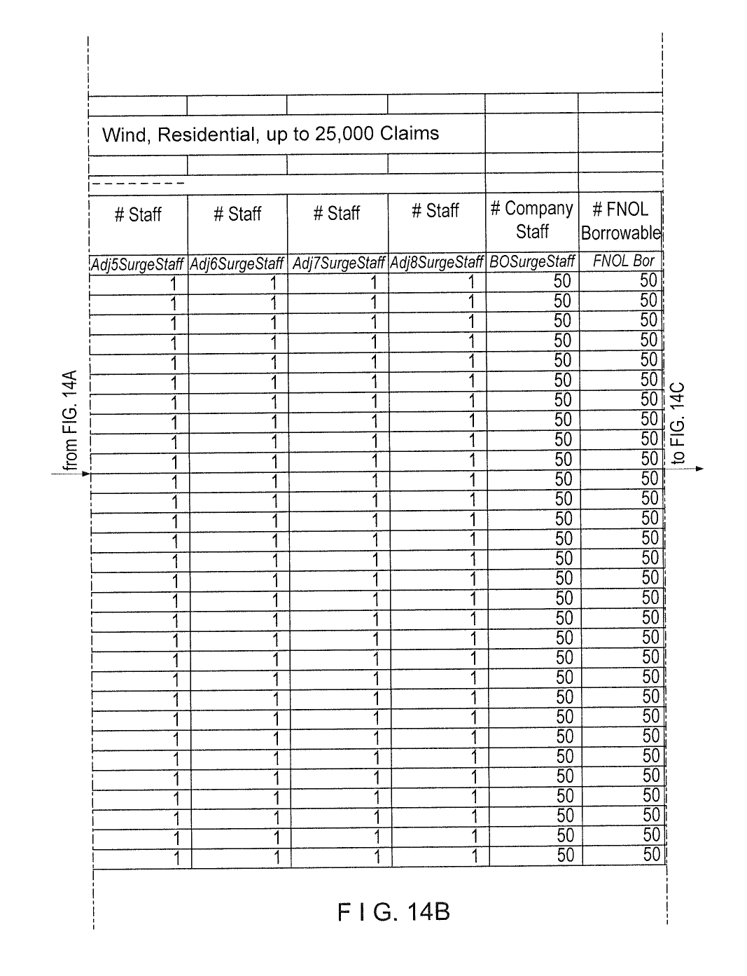

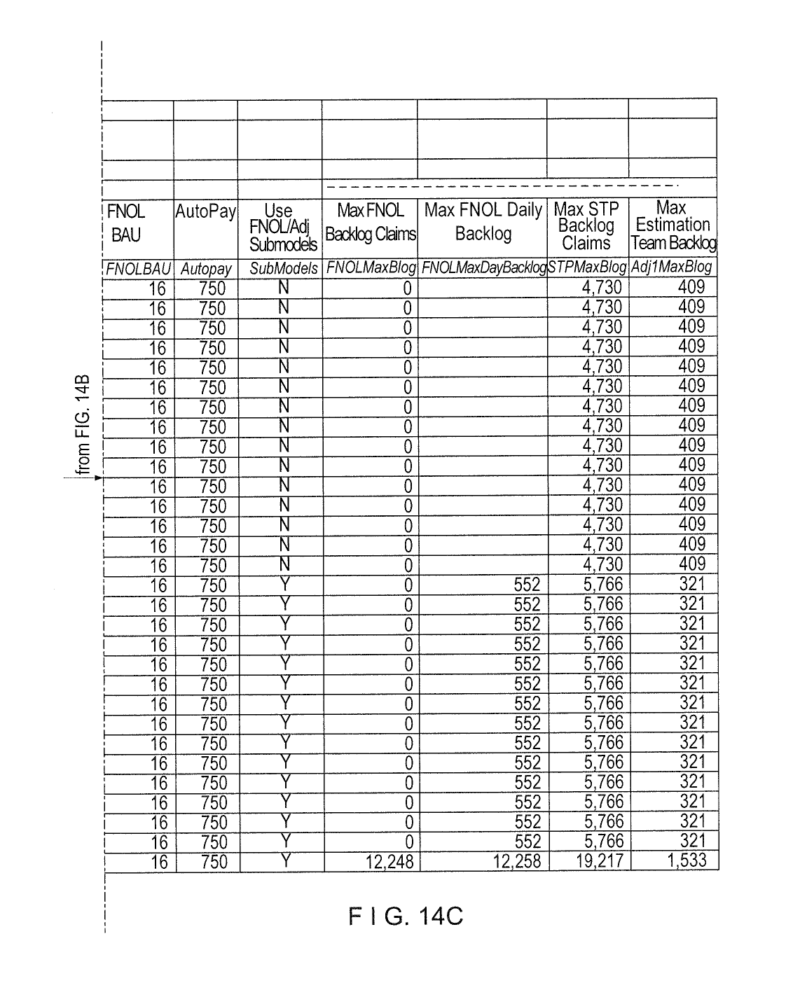

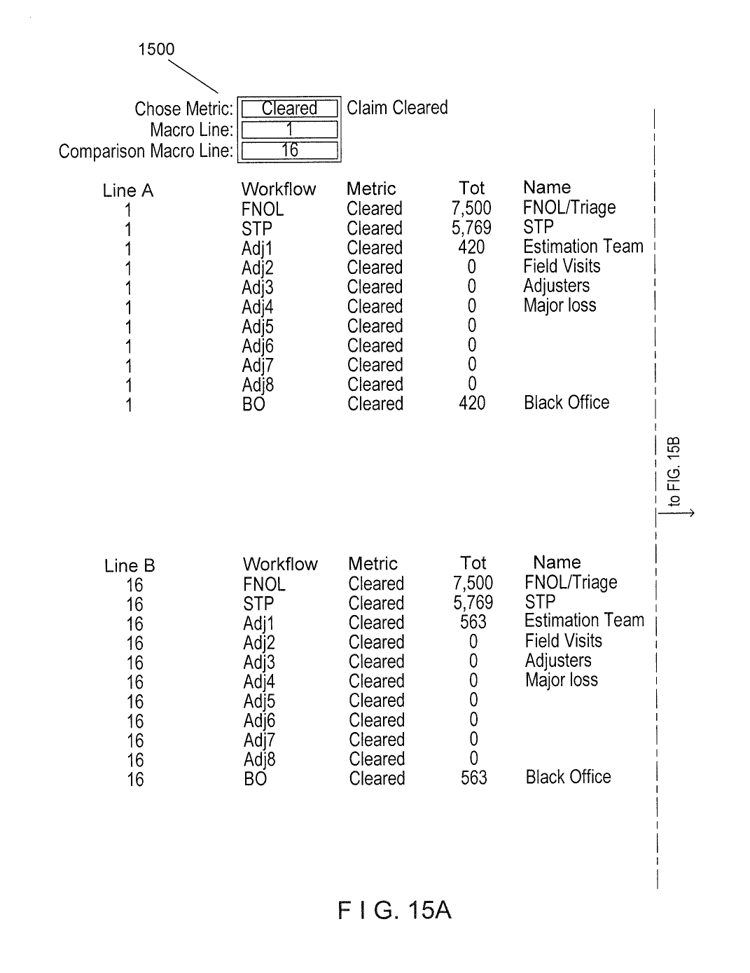

FIG. 14 shows an exemplary view 1400 that is based on the same scenario described with reference to FIG. 13, e.g., wind event with 25,000 residential claims. However, this view shows 30 alternate scenarios that have different core parameters. That is, the base scenario of a wind event with 25,000 residential claims was run with 30 different sets of input parameters. These different input parameters may be any of the variable modifiers 230 described above or differing sub-model inputs, etc. The view 1400 allows the user to see the different input parameters and the different results from the different runs using the different parameters. The user may be able to select any of these 30 alternate scenarios and display the information in the form of the dashboard view 1300. This display of alternate scenarios allows the user to see the results based on changes to, for example, staff requirements, spend, loss allocation expenses, backlogs, stress points, etc. It also allows for changing the time horizons for the scenario, e.g., daily view, weekly view, etc.

There may also be a number of other outputs, including interactive outputs that allow for the comparison of different scenarios. The following describes several examples of output views for the scenario described above, e.g., wind event with 25,000 residential claims. These views are only exemplary and are provided to illustrate the type of information that may be provided by the model and how this information could be presented to a user and subsequently used by the user to affect the claims workflow.

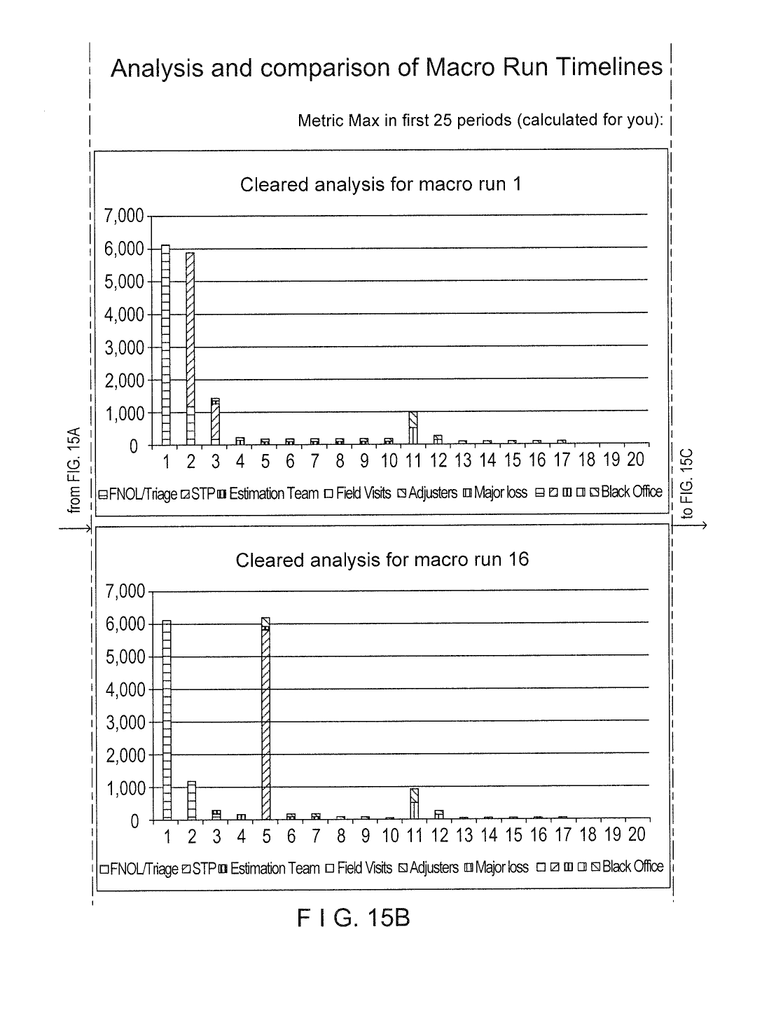

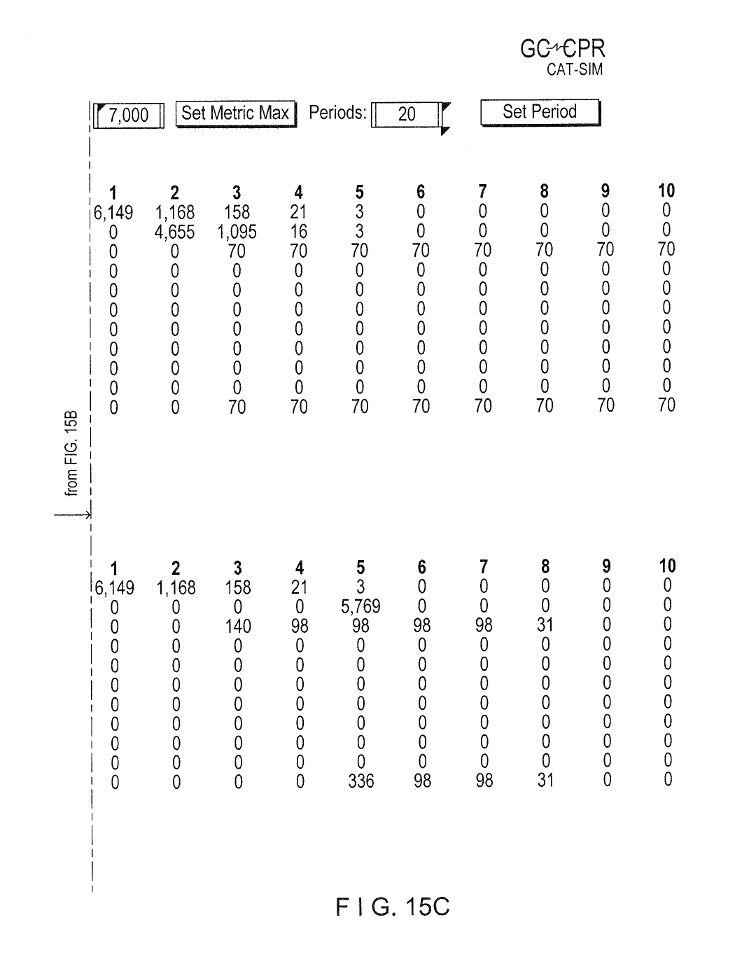

FIG. 15 shows an example of an output 1500 that allows two different user scenarios to be compared. In this example, the two scenarios that are compared are scenarios 1 and 16 as shown in the example of FIG. 14. The output allows a user to view comparative results from the two scenarios. The graphs may be interactive and may illustrate information such as staff requirements, work in progress run off in time (to show when all claims are cleared), backlogs per route and staff allocations against each workflow. This type of output may be useful for demonstrating the upside and downside of two different strategic approaches in a side-by-side comparison.

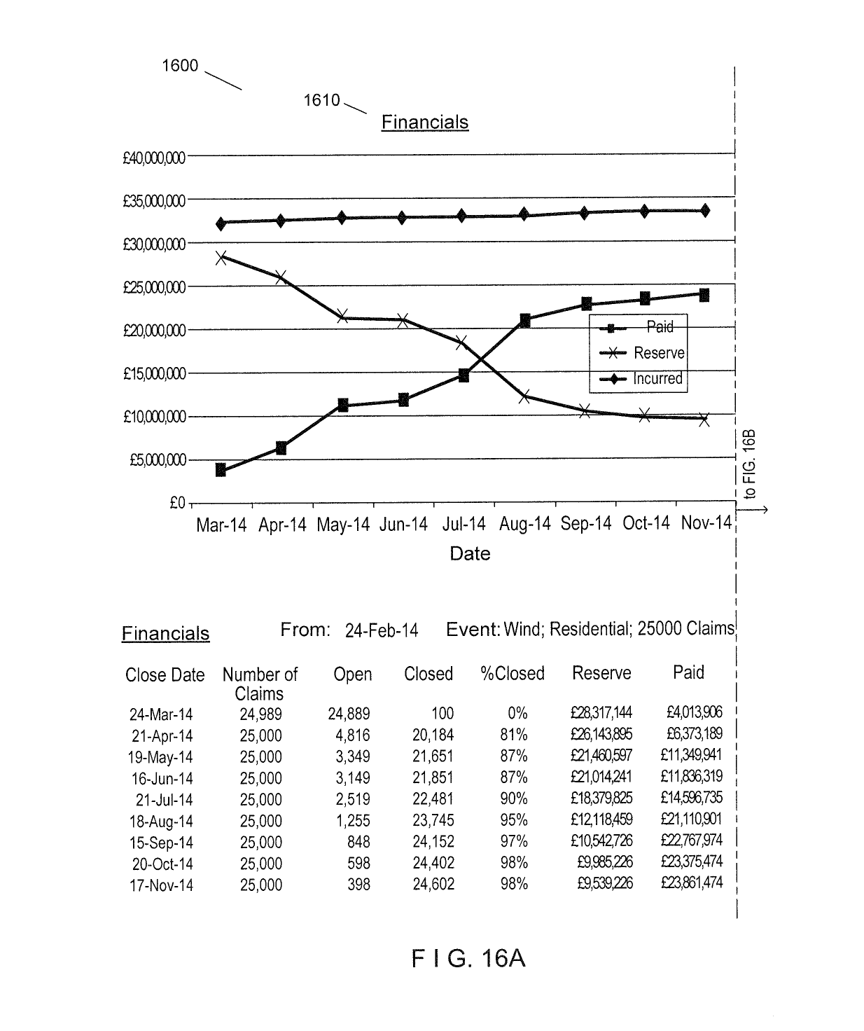

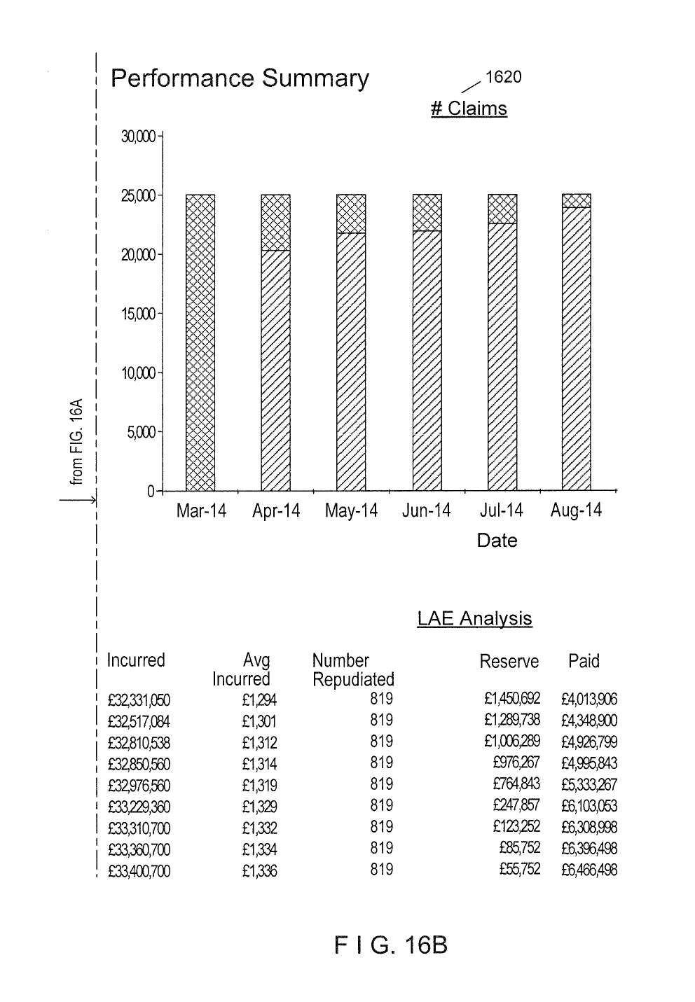

FIG. 16 shows an exemplary financial dashboard view 1600 output. Specifically, the graph 1610 shows the growth of the financial spend over time, while the graph 1620 shows the claims settled rates in time. The view 1600 also shows the information in table form.

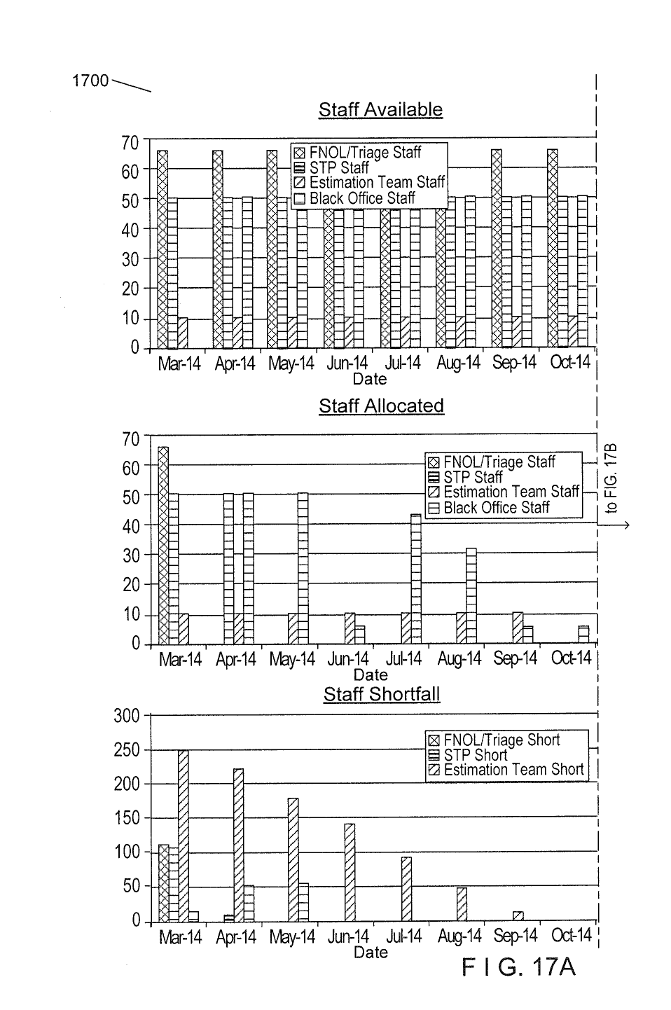

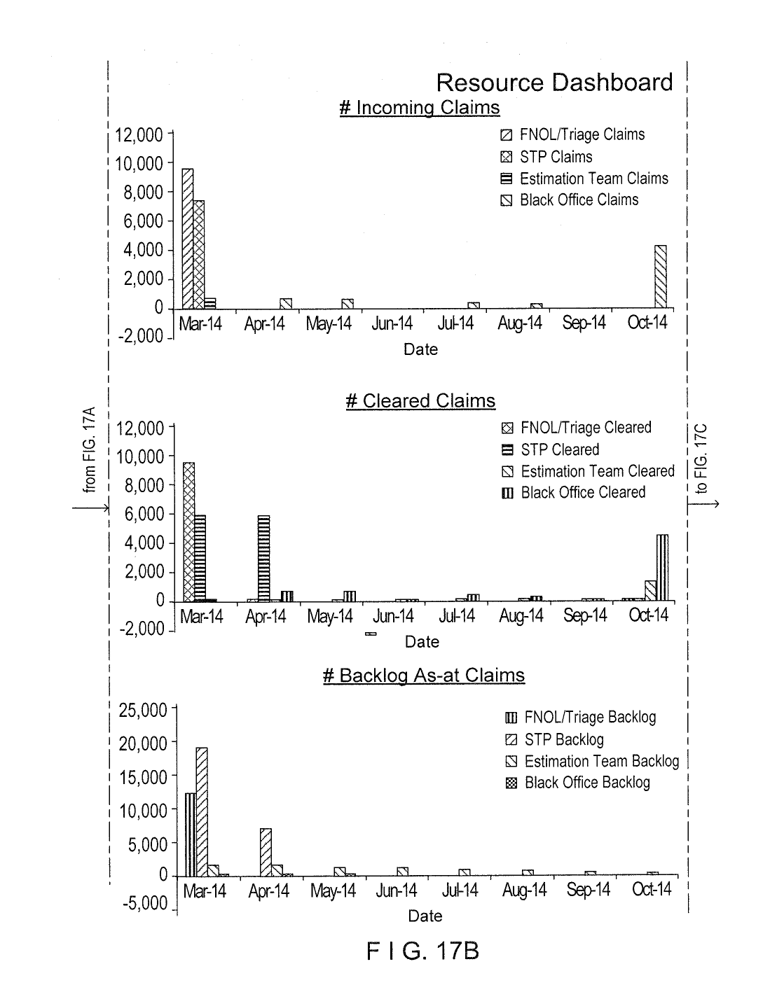

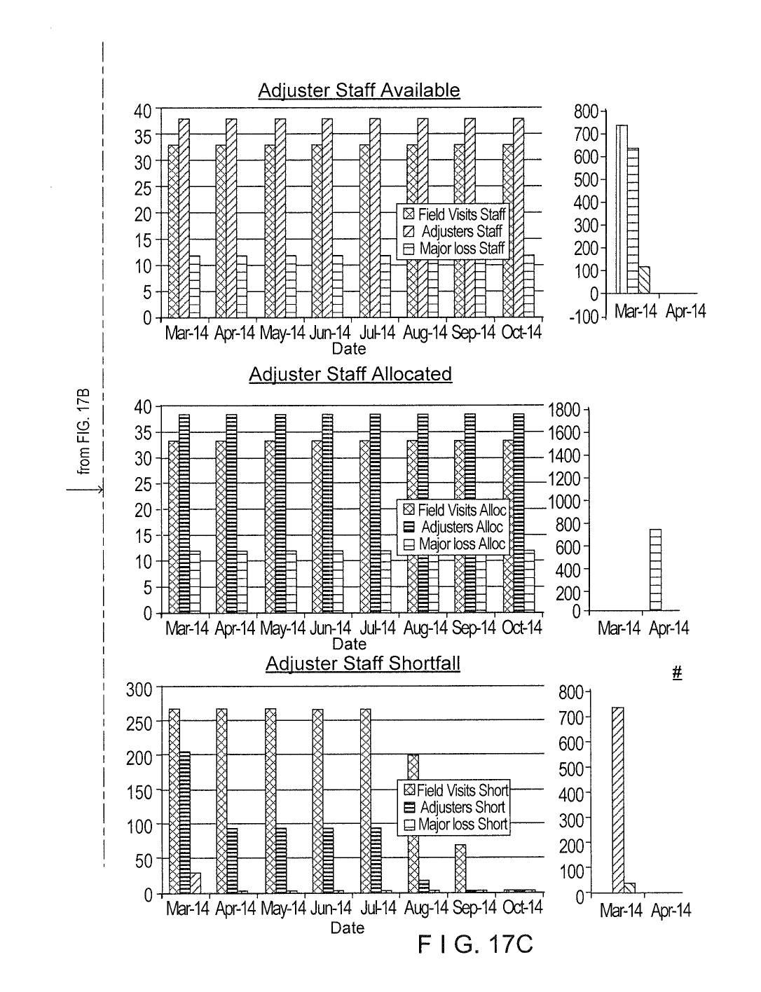

FIG. 17 shows a resource dashboard view 1700. The view 1700 shows a series of graphs that indicate the resource requirements against the workflow in time. The resource requirements include the allocation of staff, where there is a shortfall in staff and staff requirements against backlogs that may have occurred.

Another exemplary output 250 may be a database output that includes values for each run scenario and set of input variables. The database output values may be output in any format selected by the insurance company (e.g., Microsoft Excel format, Microsoft Access format, etc.).

It should be noted that the above examples could be considered an aggregate model, which takes claim bands and propagates them through workflows. The aggregate model provides output by “period” (typically weeks).

However, it is also possible to run a detailed claims model, which takes individual claims to create propagation by workflow (e.g., Straight-Through Processing (STP), Adjuster, Major Loss Team, etc.). As described above, this method may be based on actual data for a response to an actual CAT event and can be modeled more accurately as a control check of the aggregate model.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the systems and methods may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

1. A method, comprising:
receiving, by a processor, claims information for a catastrophic (“CAT”) event, the claims information including a number of claims for the CAT event;
receiving, by the processor, a plurality of variable modifiers for a response to the CAT event by an insurance company, wherein the variable modifiers include an output of at least one sub-model having a defined sub-model time period, the sub-model time period being a parameter selected to configure the sub-model, wherein the sub-model performs a probabilistic analysis of new claim arrivals within the sub-model time period;
running, by the processor, a model simulation of the response to the CAT event by the insurance company based on the claims information and the plurality of variable modifiers, wherein the model simulation is based on a defined model time period that is different from the defined sub-model time period, the model time period being a parameter used to configure the model; and
outputting results of the simulation.

2. The method of claim 1, wherein the claims information is one of expected claims for the CAT event, actual claims for the CAT event and a combination of expected and actual claims for the CAT event.

3. The method of claim 1, wherein the simulation simulates a claims journey of each of the claims from initial receipt of the claim through resolution of the claim.

4. The method of claim 1, wherein the defined model time period is one week.

5. The method of claim 1, wherein the defined sub-model time period is one of (a) one day and (b) 15 minutes.

6. The method of claim 1, wherein the claims information further includes a value of each of the claims and a quantum band for each of the claims based on the value.

7. The method of claim 1, wherein a portion of the variable modifiers include a weight.

8. The method of claim 1, wherein the model simulation includes a plurality of steps for the response and the sub-model is applied to one of the steps.

9. The method of claim 1, further comprising:
receiving an altered variable modifier; and
re-running the model simulation with the altered variable modifier.

10. The method of claim 1, further comprising:
receiving a plurality of sets of variable modifiers;
running a model simulation for each of the sets of the variable modifiers; and
displaying the model simulations for each of the sets of the variable modifiers in a comparative view.

11. A system, comprising:
a processor; and
a non-transitory computer readable storage medium that stores a set of instructions, wherein the set of instructions, when executed, cause the processor to:
receive claims information for a catastrophic (“CAT”) event, the claims information including a number of claims for the CAT event,
receive a plurality of variable modifiers for a response to the CAT event by an insurance company, wherein the variable modifiers include an output of at least one sub-model having a defined sub-model time period, the sub-model time period being a parameter selected to configure the sub-model, wherein the sub-model performs a probabilistic analysis of new claim arrivals within the sub-model time period,
run a model simulation of the response to the CAT event by the insurance company based on the claims information and the plurality of variable modifiers, wherein the model simulation is based on a defined model time period that is different from the defined sub-model time period, the model time period being a parameter used to configure the model, and
output results of the simulation.

12. The system of claim 11, wherein the claims information is one of expected claims for the CAT event, actual claims for the CAT event and a combination of expected and actual claims for the CAT event.

13. The system of claim 11, wherein the simulation simulates a claims journey of each of the claims from initial receipt of the claim through resolution of the claim.

14. The system of claim 11, wherein the defined model time period is one week.

15. The system of claim 11, wherein the defined sub-model time period is one of (a) one day and (b) 15 minutes.

16. The system of claim 11, wherein the claims information further includes a value of each of the claims and a quantum band for each of the claims based on the value.

17. The system of claim 11, wherein a portion of the variable modifiers include a weight.

18. The system of claim 11, wherein the model simulation includes a plurality of steps for the response and the sub-model is applied to one of the steps.

19. The system of claim 11, wherein the instructions further cause the processor to:
receive an altered variable modifier; and
re-run the model simulation with the altered variable modifier.

20. The system of claim 11, wherein the instructions further cause the processor to:
receive a plurality of sets of variable modifiers;
run a model simulation for each of the sets of the variable modifiers; and
display the model simulations for each of the sets of the variable modifiers in a comparative view.
